(19) United States
(12) Patent Application Publication
(10) Pub. No.: US 2024/0040400 A1
(43) Pub. Date: Feb. 1, 2024

(54) TELECOMMUNICATIONS INFRASTRUCTURE GENERATION AND PROVISIONING FOR TRANSPORT NETWORKS

(71) Applicant: VMware, Inc., Palo Alto, CA (US)

(72) Inventors: Victor Cionca, Cork (IE); Hemanth Kumar Pannem, Danville, CA (US); Akshatha Sathyanarayan, San Jose, CA (US); Archit Baweja, San Francisco, CA (US); Ki Suh Lee, San Francisco, CA (US); Sacheth Hegde, Cupertino, CA (US); Donna O'Shea, Cork (IE)

(21) Appl. No.: 17/875,343

(22) Filed: Jul. 27, 2022

(51) Int. Cl. H04W 16/22

(52) U.S. Cl. CPC H04W 16/22

(57) ABSTRACT

Some embodiments of the invention provide a method for defining a telecommunications network deployment for a particular geographic region comprised of a set of sub-regions, the telecommunications network including an access network, an edge network and a core network. For each UE of multiple UEs distributed across the particular geographic region, the method selects a traffic category from a set of traffic categories to associate with the UE, and based on the selected traffic category, the method uses an application traffic model to compute an upper threshold limit of an attainable data rate for the UE. For each link of multiple transport links that connect the multiple UEs to the telecommunications network, the method determines a link capacity for each transport link based on the upper threshold limits of the attainable data rates computed for each UE of the multiple UEs. The method simulates performance of the telecommunications network based on the determined link capacities for the multiple transport links. When a set of performance metrics resulting from simulating performance of the telecommunications network meet a performance threshold specified for the telecommunications network, the method uses the determined link capacities to define the telecommunications network deployment for the particular geographic region.

### BACKGROUND

Today, research on resource allocation for 5G networks evaluation of algorithms (e.g., for network slicing or Mobile Edge Cloud (MEC) workload offloading) requires a model of the 5G infrastructure specifying available communication and computation resources in the access network (AN), the transport network (TN), and the core network (CN). Ideally, such an infrastructure model should represent the characteristics of a real-world mobile network, allow the customization of as many parameters as possible to be able to generate multiple inputs to the problem that can stress different aspects of the algorithms, and be reproducible.

Some existing works employ network information from real Mobile Network Operators (MNOs), ranging from antenna deployment, traffic measurements, to complete network topology. The availability of such data leads to realistic scenarios. However, the data is not publicly available, and therefore it restricts the reproducibility of the work while also having little scope for customization. An alternative approach relies on network research infrastructures that have public topologies, many of which are aggregated in the SNDlib (Survivable Network Design Library), and converts these into mobile network infrastructures with the addition of access networks and compute instances. While this alternative approach enables reproducibility, there is a significant difference between research infrastructures that tend to be structured as mesh networks and a telco infrastructure that has a hierarchical topology.

### BRIEF SUMMARY

Some embodiments of the invention provide a method for deploying a telecommunications network that includes an access network, an edge network, and a core network. The method identifies, for a potential deployment of the telecommunications network for a particular geographic area, a model that includes a potential access network, a potential edge network, and a potential core network. The method then identifies locations for access nodes of the potential access network based on a predicted user equipment (UE) population density for the particular geographic area. The method computes link capacities for links connecting UEs to the potential deployment of the telecommunications network. Based on the predicted UE population density, the method simulates performance of components of the potential access, edge, and core networks. The method then deploys the potential access, edge, and core networks when the simulation meets a set of requirements specified for the telecommunications network.

To perform the simulation, some embodiments identify and/or generate multiple sets of input. In some embodiments, the input includes simulated input, input based on real-world data, or a combination of simulated and real-world data. Each input set, in some embodiments, includes a subset of inputs that are associated with a particular instance in time. In some embodiments, each input set also includes a subset of inputs for generating one or more templates for use in the simulation. For example, a subset of inputs for a particular input set in some embodiments can include data regarding dimensions of a particular geographic area, as well as population density data for the particular geographic area (i.e., population density of UEs for the particular geographic area) for generating templates that each specify a number of access nodes and locations of those access nodes for the particular geographic area. In other embodiments, the input can include pre-defined templates for numbers and locations of access nodes (i.e., a number of access nodes and a geographical layout of those access nodes). The simulations run on the provided inputs produce simulated outputs (e.g., performance metrics associated with simulated telecommunications network), which can then be analyzed to quantify network performance for each set of input.

In addition to deploying the telecommunications network, some embodiments also provide a method for determining the location and amount of compute resources to be deployed for consumption by applications of the telecommunications network. The method identifies a set of applications requiring computing resources. For each identified application, the method determines (1) per-user resource requirements for the application, (2) a number of users utilizing the application, and (3) a location at which to deploy compute resources for the application (i.e., in Points of Presence (PoPs) of the access network or in PoPs of the edge network). The method then determines an amount of compute resources to be allocated for each application based on a total number of UEs per application per PoP, and deploys the compute resources to the PoPs for consumption by the applications.

The method is performed, in some embodiments, by a network administrator using an algorithm for generating models of 5G infrastructures representing (1) the deployment or Radio Units (RUs) (i.e., access nodes) in the Radio Access Network (RAN), (2) the architecture of the transport network and the capacity of its links, and (3) the location and capacity of compute resources in the core and Mobile Edge Cloud (MEC). Such models are needed in the evaluation of network slicing or MEC deployment algorithms, according to some embodiments. The generator relies on standardized practices and specifications to obtain realistic infrastructures, in some embodiments, and enables sufficient randomization to stress all aspects of an algorithm. Example usage is discussed below for the evaluation of a Service Graph Embedding algorithm, highlighting the impact of the randomness of the generator on the algorithm's results in some embodiments.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 illustrates an example blueprint used for generating 5G telecommunications infrastructures, in some embodiments.

FIG. 2 illustrates an example of a set of code for determining maximum data rate in some embodiments.

FIG. 3 illustrates an example of a set of code for defining path loss, in some embodiments.

FIG. 4 conceptually illustrates a process of some embodiments for deploying a telecommunications network based on simulations performed using a model of a potential deployment of the telecommunications network.

FIG. 5 conceptually illustrates a process of some embodiments for dimensioning and deploying access nodes for a telecommunications network.

FIG. 6 conceptually illustrates a grid used to divide a geographic area serviced by a telecommunications network in some embodiments.

FIG. 7 conceptually illustrates an example of a grid of some embodiments divided into twenty (20) cells in which multiple access nodes are uniformly deployed based on area types of the cells.

FIG. 8 conceptually illustrates an example of a grid of some embodiments divided into nine (9) cells in which multiple access nodes are deployed based on area types of the cells.

FIG. 9 conceptually illustrates a process of some embodiments for dimensioning and provisioning the transport network links.

FIG. 10 illustrates a first graph of a simulated UE data rate and a second graph of a distribution of cell loads, in some embodiments.

FIG. 11 conceptually illustrates a process of some embodiments for deploying computing resources for a telecommunications network.

FIG. 12 conceptually illustrates a diagram for a geographic area of some embodiments covered by a telecommunications network and divided into four cells, with each cell having a different configuration of the access and edge networks.

FIGS. 13 and 14 conceptually illustrate respective diagrams after modifications to compute resource deployments for the cells illustrated in FIG. 12 have been made.

FIG. 15 illustrates an example of a 5G infrastructure graph (without the access nodes), of some embodiments.

FIG. 16 illustrates a set of code for generating a network infrastructure in some embodiments.

FIG. 17 conceptually illustrates an example of an interactive UI provided by some embodiments for viewing, analyzing, and modifying various deployments for telecommunications networks.

FIG. 18 illustrates the UI after a user has selected a view option from the dropdown menu, in some embodiments.

FIG. 19 illustrates the UI of some embodiments when an input device is used to grab and move objects displayed in the UI.

FIG. 20 illustrates the UI after the cursor is used to select a particular node in the infrastructure graph, in some embodiments.

FIG. 21 illustrates the UI of some embodiments upon receiving a selection to view resource utilization.

FIG. 22 illustrates the UI of some embodiments after a different option has been selected in the pop-up window from FIG. 20.

FIG. 23 illustrates the UI of some embodiments after modifications to compute resource deployments have been made.

FIG. 24 illustrates the UI of some embodiments after modifications to compute resource deployments and infrastructure deployments have been made.

FIG. 25 illustrates the UI of some embodiments that displays the access network portion of a telecommunications network.

FIG. 26 illustrates the UI of some embodiments when a user selects a representation of a transport link.

FIG. 27 illustrates the UI of some embodiments that displays the access, edge, and core network deployments and their components.

FIG. 28 conceptually illustrates a process of some embodiments for defining access node deployments for a telecommunications network.

FIG. 29 conceptually illustrates a set of example templates that are pre-defined for suburban area types, in some embodiments.

FIG. 30 conceptually illustrates a process of some embodiments for defining transport link deployments for a telecommunications network.

FIG. 31 conceptually illustrates another process of some embodiments for defining access node deployments for a telecommunications network.

FIG. 32 conceptually illustrates a particular geographic area of some embodiments that is divided based on population density.

FIG. 33 conceptually illustrates a process of some embodiments for defining compute resource deployments for a telecommunications network.

FIG. 34 conceptually illustrates a process of some embodiments for defining compute resources deployments for a telecommunications network for each sub-region within a particular geographic region.

FIG. 35 conceptually illustrates a process of some embodiments for displaying a visualization of a telecommunications network based on a simulation performed using access node and transport link configurations as input.

FIG. 36 conceptually illustrates a process of some embodiments for displaying a visualization of a telecommunications network following simulation of performance by the telecommunications network.

FIG. 37 illustrates a comparison, in terms of ratio of accepted service graphs, of the cases of fixed infrastructure, fixed infrastructure with randomized deployment of compute resources, and randomized infrastructure.

FIG. 38 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for deploying a telecommunications network that includes an access network, an edge network, and a core network. The method identifies, for a potential deployment of the telecommunications network for a particular geographic area, a model that includes a potential access network, a potential edge network, and a potential core network. The method then identifies locations for access nodes of the potential access network based on a predicted user equipment (UE) population density for the particular geographic area. The method computes link capacities for transport links connecting UEs to the potential deployment of the telecommunications network. Based on the predicted UE population density, the method simulates performance of components of the potential access, edge, and core networks. The method then deploys the potential access, edge, and core networks when the simulation meets a set of requirements specified for the telecommunications network.

To perform the simulation, some embodiments identify and/or generate multiple sets of input. In some embodiments, the input includes simulated input, input based on real-world data, or a combination of simulated and real-world data. Each input set, in some embodiments, includes a subset of inputs that are associated with a particular instance in time. In some embodiments, each input set also includes a subset of inputs for generating one or more templates for use in the simulation. For example, a subset of inputs for a particular input set in some embodiments can include data regarding dimensions of a particular geographic area, as well as population density data for the particular geographic area (i.e., population density of UEs for the particular geographic area) for generating templates that each specify a number of access nodes and locations of those access nodes for the particular geographic area. In other embodiments, the input can include pre-defined templates for numbers and locations of access nodes (i.e., a number of access nodes and a geographical layout of those access nodes). The simulations run on the provided inputs produce simulated outputs (e.g., performance metrics associated with simulated telecommunications network), which can then be analyzed to quantify network performance for each set of input.

In addition to deploying the telecommunications network, some embodiments also provide a method for determining the location and amount of compute resources to be deployed for consumption by applications of the telecommunications network. The method identifies a set of applications requiring computing resources. For each identified application, the method determines (1) per-user resource requirements for the application, (2) a number of users utilizing the application, and (3) a location at which to deploy compute resources for the application (i.e., in PoPs of the access network or in PoPs of the edge network). The method then determines an amount of compute resources to be allocated for each application based on a total number of UEs per application per PoP, and deploys the compute resources to the PoPs for consumption by the applications.

The method is performed, in some embodiments, by a network administrator using an algorithm for generating models of 5G infrastructures representing (1) the deployment or Radio Units (RUs) in the Radio Access Network (RAN), (2) the architecture of the transport network and the capacity of its links, and (3) the location and capacity of compute resources in the core and Mobile Edge Cloud (MEC). The models are utilized in the evaluation of network slicing or MEC deployment algorithms, according to some embodiments. The infrastructure generator relies on standardized practices and specifications to obtain realistic infrastructures, in some embodiments, and enables sufficient randomization to stress all aspects of an algorithm. Example usage is discussed below for the evaluation of a Service Graph Embedding algorithm, highlighting the impact of the randomness of the generator on the algorithm's results in some embodiments.

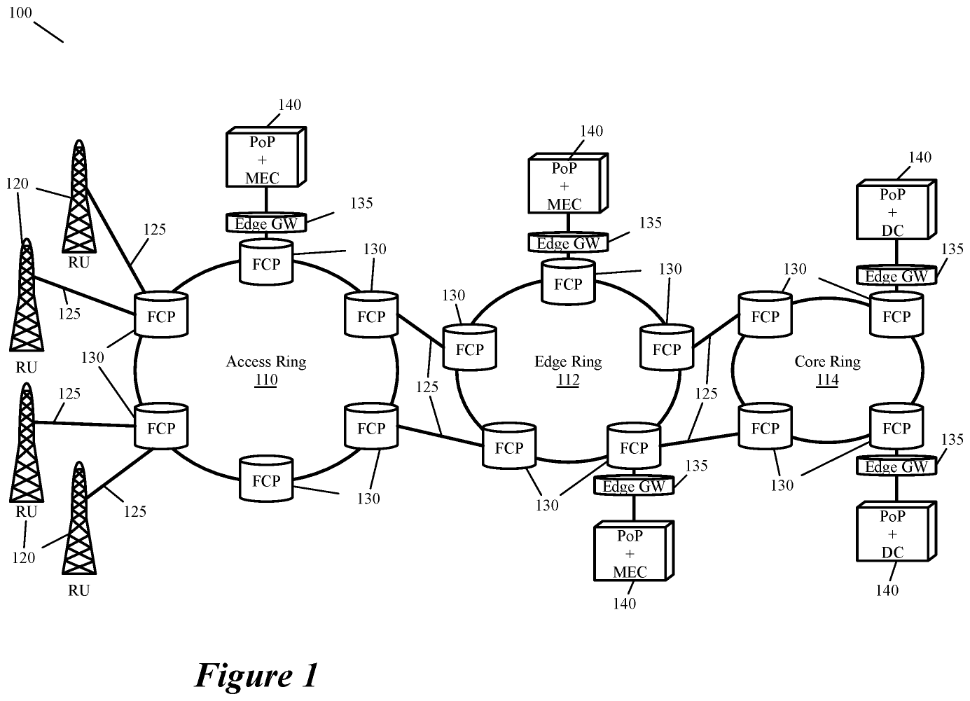

FIG. 1 illustrates an example blueprint used for generating 5G telecommunications infrastructures, in some embodiments. The blueprint 100 in some embodiments utilizes aspects of the IEEE 1914.1 standard, which covers the next generation fronthaul interface (NGFI) architecture for packet-based fronthaul transport networks. NGFI provides flexibility in achieving strict latency requirements and throughput requirements for 5G RANs (e.g., centralized RANs (C-RANs) and virtualized RANs (vRANs)), according to some embodiments. Additionally, NGFI in some embodiments enables baseband processing functions of a radio frequency signal to be split between radio unit (RU), distributed unit (DU), and central unit (CU), such that the RU, DU, and CU may be located at different sites of the telecommunications network. In some embodiments, the data in such telecommunications networks is transmitted between the RU, DU, and CU as packets that are routed via forwarding elements (e.g., switches) over a shared packet-based fronthaul transport network as described herein.

As illustrated, the blueprint 100 includes an access ring 110, an edge ring 112, and a core ring 114. The access ring, edge ring, and core ring are representative of an access network, edge network, and core network of a telecommunications network, according to some embodiments. As shown, each of the rings 110-114 includes one or more Points of Presence (PoPs) and one or more Fiber Concentrator Points (FCPs). The PoPs, in some embodiments, are local access points for service providers (i.e., Internet service providers (ISPs)) that include call aggregators, routers, switches, and other forwarding elements, as well as servers, multiplexers, and other devices for network interfacing. Each PoP includes one or more IP (Internet protocol) addresses, as well as IP address pools that include IP addresses that can be assigned to users of the telecommunications network, according to some embodiments. In some embodiments, the PoPs also include compute resources for hosting MECs or core datacenters that provide network services to end-users (e.g., via applications hosted by the MECs and core datacenters). MECs, in some embodiments, enable cloud-like capabilities to be employed at edges of the telecommunications network, while the core datacenters are used to house network functions virtualization (NFV) functions and network management components for managing other sites (e.g., MECs) of the network in a central location.

In some embodiments, the compute resources that are allocated to the PoPs (i.e., allocated for consumption by applications deployed in the telecommunications network) are deployed to machines located in the PoPs, such as the servers mentioned above. The machines, in some embodiments, also include virtual machines (VMs), containers, and pods deployed in the MECs and core datacenters at the PoPs. In some embodiments, the compute resource deployments for applications also specify the machines (e.g., VM, container, etc.) to which the compute resources are to be deployed. As will be described further below, compute resources are allocated to the PoPs, in some embodiments, according to determinations made using algorithms based on the blueprint 100.

In some embodiments, the FCPs provide high-speed, centralized connection points for the telecommunications network. The FCPs of some embodiments include forwarding elements, such as routers. Each FCP in the access ring, for instance, connects 36 access nodes. The access nodes of some embodiments are aggregated gNBs (i.e., new radio (NR) logical nodes) using an NGC (next generation core) interface. In other embodiments, the access nodes are disaggregated (Radio Unit-Distributed Unit-Central Unit (RU-DU-CU)) using F1 interfaces (i.e., open interfaces where the endpoint can be from different vendors) or Fx interfaces (i.e., open interface for a 5G RAN), with each interface having different peak data rates. As mentioned above, the disaggregated access nodes may be located at different sites across the telecommunications network.

The access ring, in some embodiments, includes 16 FCPs and 4 PoPs. Each access ring 110 connects into the edge ring 112 through an FCP 130, in some embodiments, and each edge ring includes 5 FCPs, as well as two PoPs. As illustrated, the two PoPs 140 of the edge ring 112 have MEC resources (e.g., CPU, GPU, memory, and storage resources for processing packets transmitted by the telecommunications network). Finally, the edge ring 112 connects to the core ring 114 via FCPs 130. The core ring 114 includes two PoPs each hosting a datacenter that has compute resources both for services as well as for 5G core NFs (network functions).

In some embodiments, the UE population is simulated as a 2D probability density function (PDF), which can consist of a single PDF or a sum of PDFs. While the simulated data of some embodiments is not necessarily representative of the real-world, it allows the generation of a wide range of environments and resulting infrastructures, and is, in some embodiments, more flexible than organic, real-world data. In some embodiments, after generating the UE PDFs over an area of interest, the area is divided into a grid and the area type (i.e., dense urban, suburban, or rural) for each cell within the grid is determined based on its population density, as will be further described below.

In some embodiments, the load of a cell is considered a cumulative process consisting of a set of UEs from the cell that generate traffic demands, with each UE's data rate limited by the Modulation and Coding Scheme (MCS) assigned by the cell depending on the quality of the signal to and from the UE. To this extent, the load distribution for a cell is obtained in some embodiments by (1) sampling a set of UEs and their locations in the cell using a Poisson Point Process; (2) for each UE selecting with equal probability one of three traffic types: web browsing, file transfer, or video streaming; (3) sampling a traffic demand from the application traffic model; and (4) computing the maximum data rate attainable by the UE, given its distance from the antenna and a path loss model, with the final load being the minimum between the maximum attainable data rate and the UE's traffic demand.

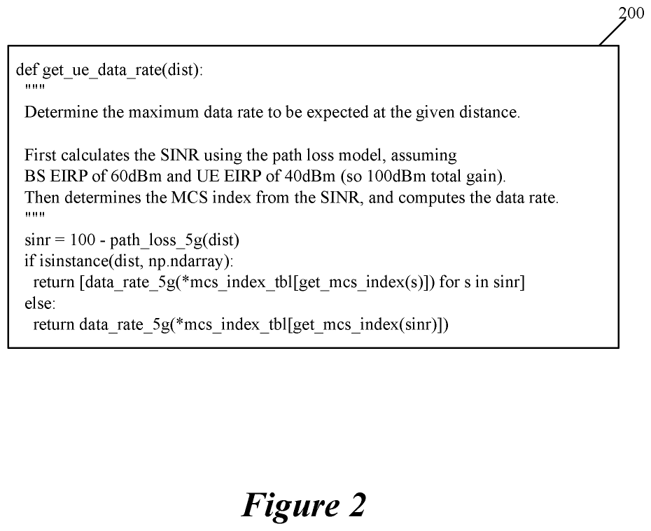

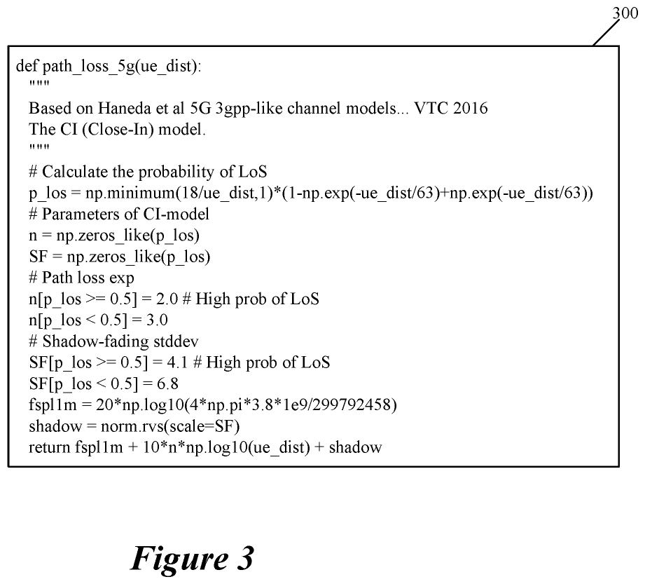

FIG. 2 illustrates an example of a set of code 200 for determining maximum data rate in some embodiments. As shown, the maximum data rate is the expected maximum data rate based on distance between a UE and an access node. The data rate utilizes a path loss model as mentioned above, which relies on a path loss exponent that is calculated based on a probability of Line of Sight between the UE and the nearest access node, according to some embodiments. For instance, FIG. 3 illustrates an example of a set of code 300 for defining path loss, in some such embodiments. It should be noted that the sets of code 200 and 300 are exemplary and may be different in different embodiments.

In some embodiments, generating a 5G infrastructure based on the blueprint 100 requires (1) deploying access nodes (e.g., RUs or gNBs); (2) establishing connections between the access nodes and the access rings, establishing connections between the access rings and the edge rings, establishing connections between the edge rings and the core rings, and calculating the required TN capacity based on population density and user data; and (3) deploying compute resources.

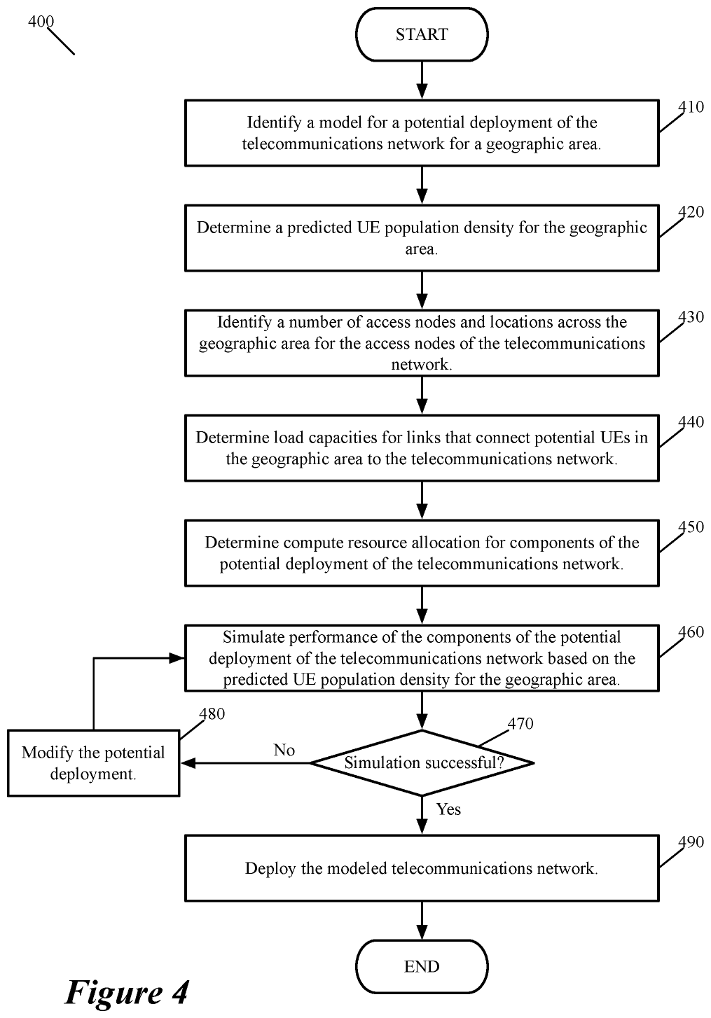

FIG. 4 conceptually illustrates a process of some embodiments for deploying a telecommunications network based on simulations performed using a model of a potential deployment of the telecommunications network. In some embodiments, the process 400 is performed through a user interface (UI) by a network administrator using one or more algorithms. The model used in some embodiments includes a potential access network, a potential edge network, a potential core network, and multiple components (e.g., access nodes, PoPs, FCPs, etc.) for the telecommunications network, such as the access ring 110, edge ring 112, core ring 114, and components 120, 130, 135, and 140 in the blueprint 100 described above.

The process 400 starts when the network administrator identifies (at 410) a model for a potential deployment of the telecommunications network for a geographic area. For instance, the network administrator of some embodiments may identify a model such as the blueprint 100. In some embodiments, the geographic area may include a particular county, city, region (e.g., a major city and its surrounding area), etc. across which the telecommunications network is to be deployed.

The process 400 determines (at 420) a predicted UE population density for the geographic area. In some embodiments, the predicted UE population density is determined based on actual population data for the geographic area (e.g., historical population data obtained through a census), while in other embodiments, the UE population density data is determined using a population density function. For example, some embodiments simulate a UE population as a 2-dimensional (2D) probability density function (PDF). The 2D PDF is a single PDF in some embodiments, and a sum of PDFs in other embodiments.

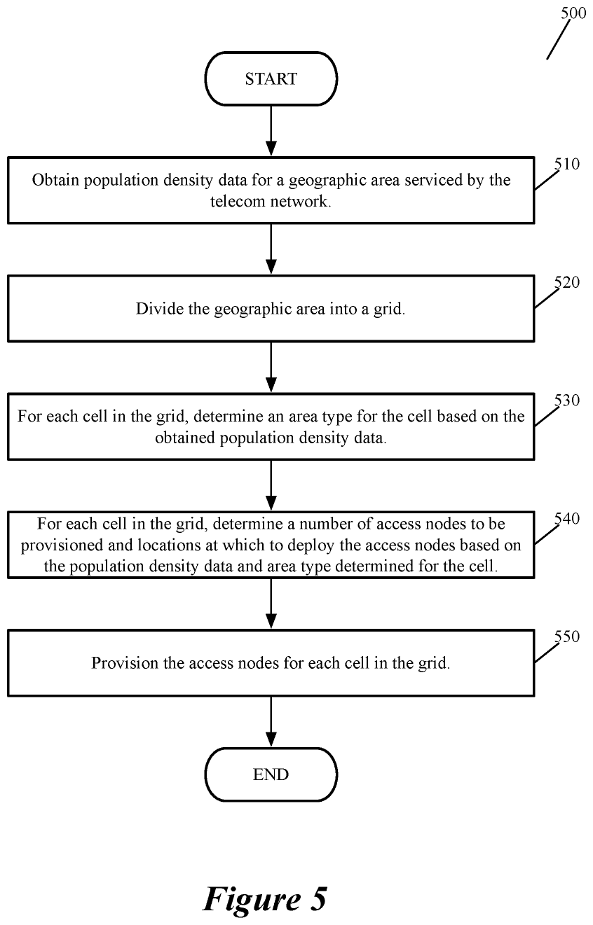

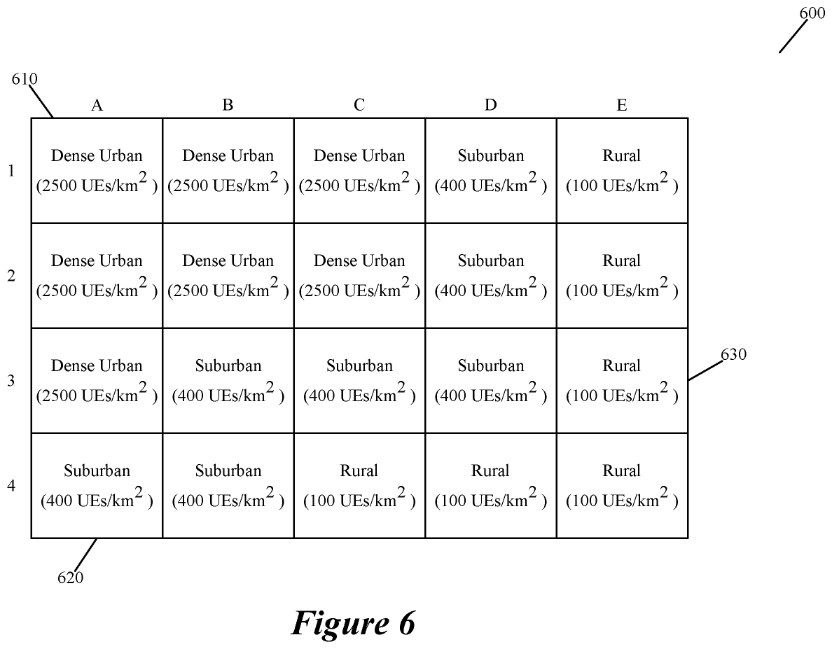

The process 400 identifies (at 430) a number of access nodes and locations across the geographic area for the access nodes of the telecommunications network. The access nodes connect to FCPs of a potential access network and provide connections between UEs and the telecommunications network. The access nodes of some embodiments can be aggregated gNBs using an NGC interface, or disaggregated RU-DU-CU using F1 interfaces or Fx interfaces. The locations of the access nodes are determined, in some embodiments, according to area type (e.g., dense urban, suburban, rural) as well as relative distance to the UEs of the geographic area. Additional details regarding determining a number and locations of access nodes will be further described below by reference to FIGS. 5 and 6.

The process 400 determines (at 440) load capacities for transport links that connect potential UEs in the geographic area to the telecommunications network. In the blueprint 100, for example, the process would determine load capacities for the transport links 125 between the access nodes 120 and the FCPs 130 of the access ring 110, as well as the transport links 125 that connect the FCPs 130 of the access ring 110 to the FCPs 130 of the edge ring 112, and the FCPs 130 of the edge ring 112 to the FCPs 130 of the core ring 114. The transport links of some embodiments include wired and wireless links, point-to-point links, broadcast links, multipoint links, point-to-multipoint links, public links, and private links. The wired links of some embodiments can include, e.g., coaxial cables and fiber optic cables. In some embodiments, the load capacities are determined based on maximum loads predicted using the population density for the geographic area. The link capacity for the transport links, in some embodiments, is equal to the link capacity required to support at least 95% of the maximum load predicted.

The process determines (at 450) compute resource allocation for components of the potential deployment of the telecommunications network. In the blueprint 100, for instance, the process would determine compute resource allocation for the PoPs 140 that can host datacenters and MECs. The compute resources are for consumption by applications implemented in the datacenters and MECs hosted by the PoPs, according to some embodiments. In some embodiments, determining compute resource allocation includes determining both the quantity of compute resources to be deployed as well as the locations (i.e., at which PoPs) the compute resources will be deployed.

The process 400 simulates (at 460) performance of the components of the potential deployment of the telecommunications network based on the predicted UE population density for the geographic area. The simulation, in some embodiments, can be used to determine whether the allocated compute resources are sufficient for processing and servicing packets transmitted across the telecommunications network, as well as to determine whether the locations of the access nodes and load capacities of the links between the access nodes and FCPs are sufficient to, e.g., meet service agreements (e.g., latency requirements) of the applications implemented across the telecommunications network.

The process determines (at 470) whether the simulation was successful. That is, the process determines whether any modifications are needed to improve performance of the potential deployment. When the process determines that the simulation was not successful, the process transitions to modify (at 480) the potential deployment. In some embodiments, a network administrator may modify the quantity of resources allocated, the locations of the allocated resources, the locations of the access nodes, etc. to achieve a desired result (e.g. to meet a latency requirement of a particular application). The process then returns to 460 to simulate the performance of the potential deployment. When the simulation is determined to be successful, the process 400 transitions to deploy (at 490) the modeled telecommunications network for the geographic area. Following 490, the process 400 ends. It should be noted that, in some embodiments, all or part of the process 400 may be performed to modify existing telecommunications networks (e.g., to improve performance).

FIG. 5 conceptually illustrates a process of some embodiments for dimensioning and deploying access nodes for a telecommunications network. The process 500 is performed by a network administrator through a UI, in some embodiments. In some embodiments, the process 500 is performed as part of the step 430 in the process 400 described above.

The process 500 starts when the network administrator obtains (at 510) population density data for a geographic area serviced by, or to be serviced by, a telecommunications network. In some embodiments, the population density data is obtained by simulating a UE population as a 2D probability density function (PDF), that may include a single PDF or a sum of PDFs. In other embodiments, the population density data is obtained from real-world data, such as from a census.

The process 500 divides (at 520) the geographic area into a grid. For example, FIG. 6 conceptually illustrates such a grid of some embodiments. The grid 600 is divided into twenty (20) cells, with each cell representing a portion of the geographic area serviced by, or to be serviced by, the telecommunications network. In some embodiments, the grid may be divided into more cells than shown by the grid 600, while in other embodiments, the grid may be divided into fewer cells than shown.

For each cell in the grid, the process 500 determines (at 530) an area type for the cell based on the obtained population density data. The area types, in some embodiments, are specified as follows: areas having 2500 UEs/km² are classified as dense urban areas, areas having 400 UEs/km² are classified as suburban areas, and areas having 100 UEs/km² are classified as rural areas. Each cell in the grid 600, for instance, is designated as dense urban (e.g., cell 610), suburban (e.g., cell 620), or rural (e.g., cell 630) based on the number of UEs per km² within the cell's corresponding geographic area. Assuming, for example, that each cell represents 400 km², a dense urban area cell 610 would be representative of 1 million UEs, a suburban area cell 620 would be representative of 160,000 UEs, and a rural cell would be representative of 40,000 UEs.

For each cell in the grid, the process 500 determines (at 540) a number of access nodes to be provisioned and locations at which to deploy the access nodes based on the population density data and the area type determined for the cell. In some embodiments, the access nodes are deployed in a uniform manner following an ISD (inter-site distance) specified by the 3GPP (3^{rd} Generation Partnership Project), which indicates ISDs of 200 m in dense urban areas, 500 m in suburban areas, and 1.7 km in rural areas. Based on these ISDs, the cells 610 representing dense urban areas would each require approximately 10,000 access nodes, the cells 620 representing suburban areas would each require approximately 1,600 access nodes, and the cells 630 representing rural areas would each require approximately 121 access nodes.

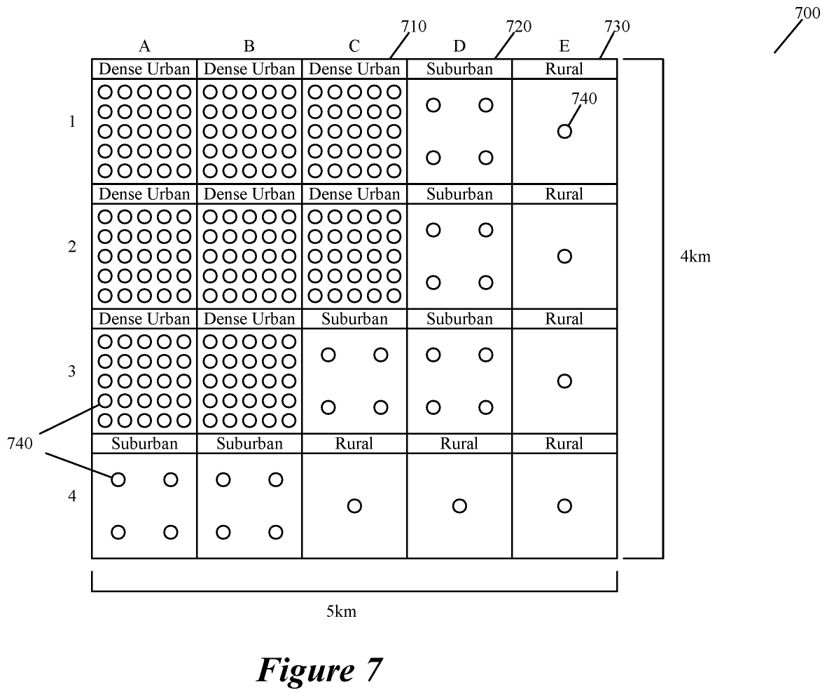

The process 500 then provisions (at 550) the access nodes for each cell in the grid. FIG. 7 conceptually illustrates an example of a grid of some embodiments divided into twenty (20) cells in which multiple access nodes are uniformly deployed based on area types of the cells. In this example, each of the cells within the grid 700 measures 1 km². As such, based the ISDs mentioned above, each of the dense urban cells 710 include 25 access nodes 740, each of the suburban cells 720 include 4 access nodes 740, and each of the rural cells 730 include 1 access node 740 (rounded down from 1.7 for simplicity). As will be described below, while the access nodes of some embodiments are provisioned and deployed in a uniform manner like the access nodes 740, the access nodes in other embodiments may be provisioned and deployed non-uniformly based on factors such as where in a region (i.e., a cell) UEs are most concentrated. Returning to the process 500, following 550, the process 500 ends.

In some embodiments, the access nodes are be deployed throughout a region to provide more support for specific locations at which UE populations are determined to be more concentrated (e.g., based on population density data). For instance, a high-traffic roadway (e.g., an interstate highway) may run through a rural area and create a need for one or more of the access nodes to be in closer proximity to the high-traffic roadway in order to provide sufficient service to UEs traveling on the high-traffic roadway than a uniform deployment would allow, according to some embodiments.

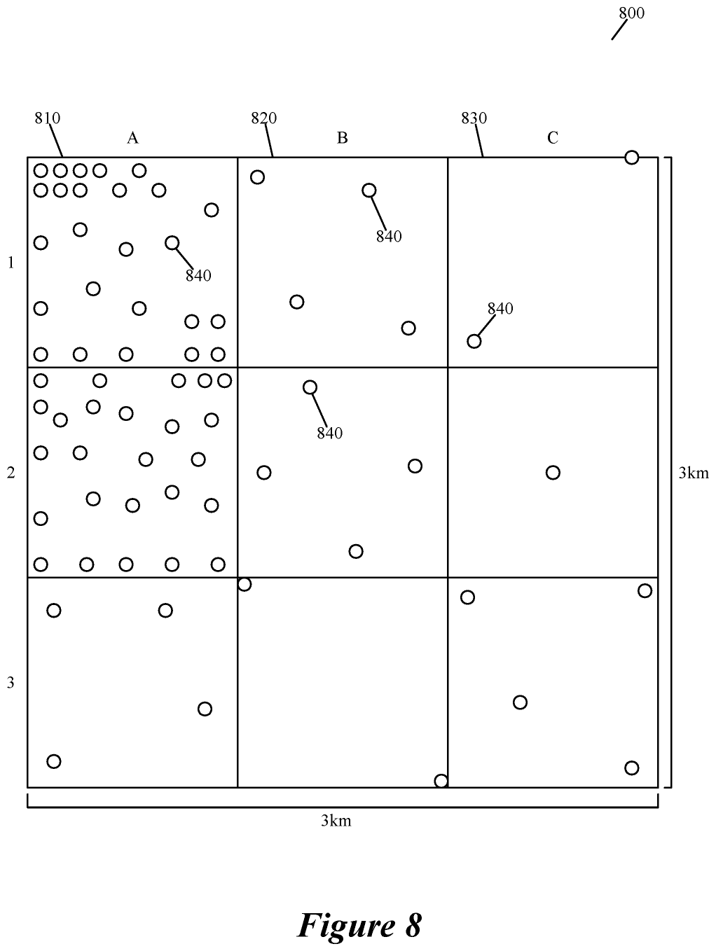

FIG. 8 conceptually illustrates an example of a grid of some embodiments divided into nine (9) cells in which multiple access nodes are deployed based on area types of the cells. Unlike the access nodes 740 in the grid 700, the access nodes 840 are deployed non-uniformly. In some embodiments, access nodes are deployed in a non-uniform manner to ensure consistent services are provided to specific areas within each region where the population is more concentrated (e.g., tourist destinations, higher concentrations of multi-tenant housing complexes, etc.). As shown, each cell, regardless of area type, illustrates a slightly different deployment of access nodes 840.

The cell 810, for instance, is a dense urban cell in which the access nodes 840 are deployed in a more concentrated manner in the top left of the cell. In the cell 820, which is a suburban area, the access nodes 840 may still follow a particular ISD, while also arranging the access nodes in a manner that ensures the best possible service for UEs within the cell. Lastly, the cell 830 is a rural area in which approximately two access nodes 840 are deployed at opposing corners of the cell.

In some embodiments, the placements of the access nodes may be indicative of interstate highway locations, or other high-traffic roadways, that run through the rural area within the cell. For example, the I-5 in California traverses a variety of area types throughout the state, including rural areas where the population density of UEs is markedly lower than other areas of the state. As such, access nodes within these rural areas may be placed closer to the I-5 to provide reliable service to UEs traveling along the I-5. In some embodiments, the compute resources deployed for these rural areas may also be deployed strictly to PoPs in the access network to mitigate service interruptions that may result from the fewer number of access nodes providing access to the telecommunications network for the UEs traveling along the interstate. Additional details regarding compute resource deployments will be described further below.

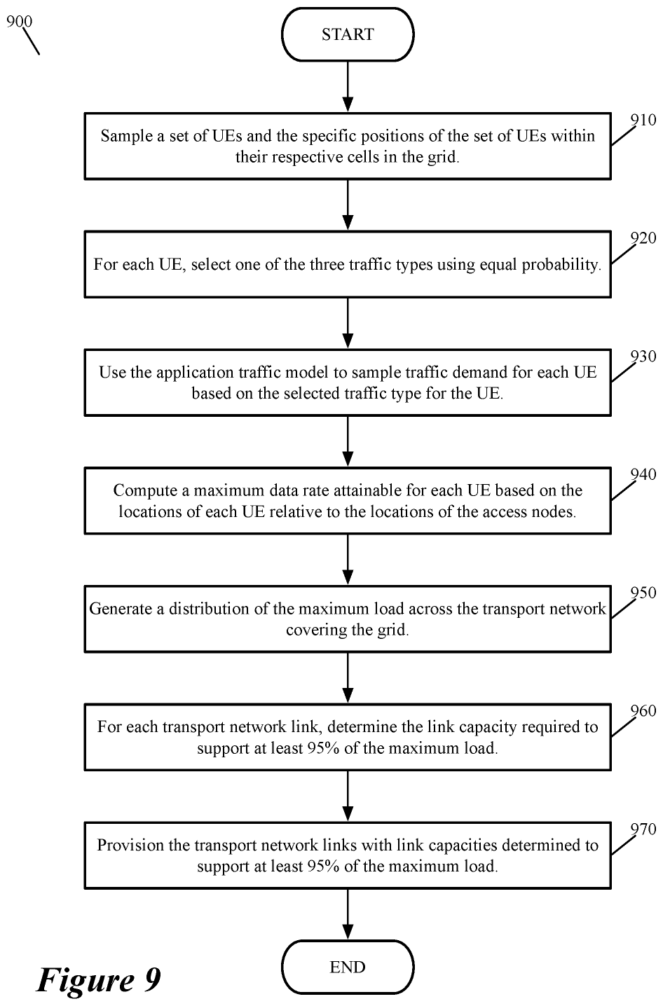

In addition to determining number of and locations of access nodes for a telecommunications network, some embodiments also must determine load capacities for transport network links that provide connections between the access nodes and the core network and/or to the various MECs hosted by PoPs. Each network segment, in some embodiments, conveys traffic for a number of cells within the grid (e.g., the grid 600), with more cells aggregated per segment when closer to the core. Each segment must have enough capacity to support the conveyed traffic, and that is calculated under the assumption that the MNO (mobile network operator) will use statistical multiplexing, in some embodiments. FIG. 9 conceptually illustrates a process of some embodiments for dimensioning and provisioning the transport network links. Like the processes 400 and 500, the process 900 is performed in some embodiments by a network administrator (e.g., MNO) through a UI.

The process 900 starts when the network administrator samples (at 910) a set of UEs and the specific locations of the set of UEs within their respective cells in the grid. In some embodiments, this sampling is performed using a Poisson Point Process, where the average time between events is known, while the actual timing of the events is random. For example, every M hours, for a period of N hours, the majority of UEs are clustered in a particular area of their respective cell in the grid.

For each UE, the process 900 selects (at 920) one of three traffic types using equal probability. The traffic types, in some embodiments, include web browsing, file transfer, and video streaming. Different traffic types are associated with different data rates, in some embodiments. In some embodiments, the UEs may request certain data rates based on the traffic type transmitted by the UE. For instance, a hypothetical UE may request a higher data rate for, e.g., video streaming and a lower data rate for, e.g., web browsing. In other embodiments, the UEs may be categorized in a different manner. For instance, other embodiments may assign each UE a category based on percentages of types of data flows to and from the UE, such as phone calls, video conference calls, video streaming, audio streaming, etc. by the UE. In still other embodiments, each UE may be categorized based on thresholds defined for traffic usage types, such as light phone use, heavy phone use, light audio streaming, heavy audio streaming, etc.

The process 900 uses (at 930) an application traffic model to sample traffic demand for each UE based on the selected traffic type for the UE. The application traffic models of some embodiments are generated as follows. For web browsing traffic, in some embodiments, packet sizes follow a lognormal distribution truncated between 100B and 2 MB, μ=25032B, σ=10710B, and reading times (i.e., inter-packet intervals) are exponentially distributed, with μ=30 s. File transfer is based on an NGMN model, in some embodiments, with packet sizes lognormally distributed truncated between 1B and 5 MB, μ=2 MB, σ=0.722 MB, and reading time exponentially distributed with μ=180 s. Video streaming, in some embodiments, is based on Deliverable 6.1 of METIS-I, with constant frame size of 1.66M B at an exponentially distributed interval with μ=33 ms.

The process 900 computes (at 940) a maximum data rate attainable for each UE based on the locations of each UE relative to the locations of the access nodes. As mentioned above, the UE, in some embodiments, requests a certain data rate based on the traffic type. However, that requested data rate cannot exceed the maximum data rate attainable by the UE, which is determined in some embodiments by the MCS assigned to the UE by the RAN controller depending on the signal quality of the UE. If the UE experiences good signal, a high order MCS will be assigned resulting in high data rates, in some embodiments. However, if the signal is poor, the MCS of some embodiments will be lowered, and with that, the data rate will also be lowered in order to maintain communication reliability, according to some embodiments.

The process 900 generates (at 950) a distribution of the maximum load across the transport network covering the grid. The load of each cell is characterized in some embodiments by an average and a peak. First, the connection between a cell and the access ring FCP, which conveys only traffic for that cell, must be able to support the peak rate, in some embodiments. According to the 3GPP, for example, the peak rate is ≈6 Gbps for aggregated gNB (e.g., NGC interface) for a high-level split option (e.g., F1 interface), and ≈25 Gbps for a low-level split option (e.g., Fx interface). When aggregating k cells, it is likely in some embodiments that the peaks of the cells will not occur at the same time, and therefore it is not necessary to support k×peak. The total cell load of some embodiments is obtained by summing the load from a set of UEs, with the number of UEs in the cell depending on the area type of the cell (i.e., 2500 UEs/km² specified for dense urban areas, 400 UEs/km² specified for suburban areas, and 100 UEs/km² specified for rural areas).

For each transport network link, the process 900 determines (at 960) the link capacity required to support at least 95% of the maximum load. Because the peaks of the cells will not occur at the same time, as mentioned above, a statistical model of the aggregated load can be developed, and the link provisioned for, e.g., 95% of the aggregated load. In some embodiments, the statistical model is developed using Monte Carlo (MC) simulations by first simulating the UE traffic demands of a cell and subsequently aggregating the traffic of a given number of cells. That is, when dimensioning a TN link that conveys traffic for k cells, some embodiments first generate the distribution of the aggregated load consisting of 10,000 random samples of sums of k cell loads from the above distribution, and obtain the link capacity needed to support 95% of the aggregated load as the value of Q(0.95), where Q is the quantile function over the aggregated load distribution. Following obtainment of the total cell load, MC simulations are used to sample 1000 cell loads following the above process and develop a distribution of the cell load.

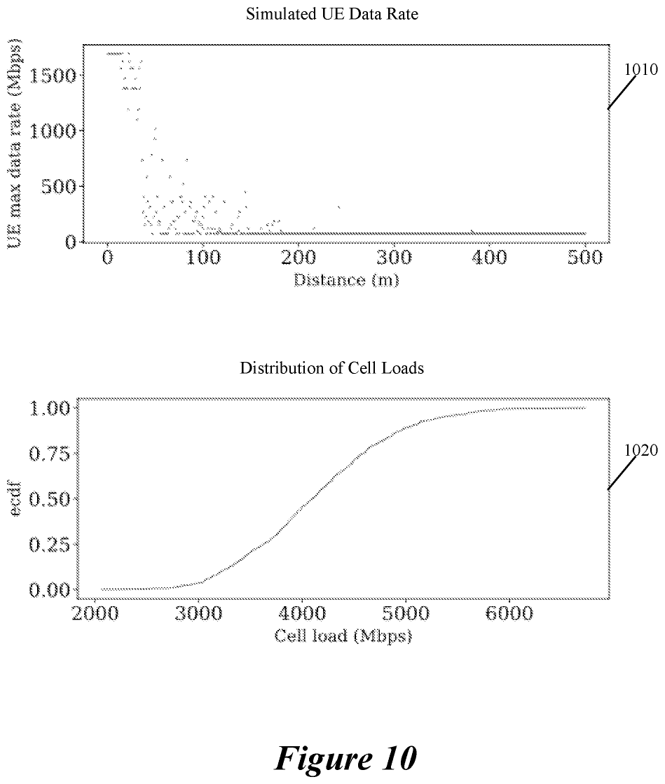

FIG. 10 illustrates a first graph 1010 of a simulated UE data rate and a second graph of a distribution of cell loads 1020, in some embodiments. As shown, the graph 1010 shows that the maximum data rate (in Mbps) decreases exponentially as the distance (in meters) increases. In other words, the greater the distance, the lower the maximum data rate. The graph 1020 shows the distribution of cell loads as an estimator of the cumulative distribution function.

The process 900 provisions (at 970) the transport network links with link capacities determined to support at least 95% of the maximum load. Following 970, the process 900 ends. The TN links collectively make up the transport network of the telecommunications network, in some embodiments, and the transport network is generated following the blueprint in FIG. 1 and the processes 400, 500, and 900 described above, according to some embodiments. For example, the access nodes of some embodiments are grouped into access ring FCPs by partitioning the RAN (i.e., access network) into sub-areas of 36 RUs (e.g., access nodes). The interface is then set to high level (e.g., NGC or F1) or low level split (e.g., Fx) with configurable probability, in some embodiments. FCPs, in some embodiments, are subsequently clustered into access, edge, and finally core rings. The number of aggregated access nodes is then determined for each TN segment, in some embodiments, and the TN links are dimensioned and provisioned with the required link capacities. The access, edge, and core rings, in some embodiments, represent access, edge, and core networks for the telecommunications network.

In some embodiments, CPU, GPU, memory, and storage resources are distributed throughout the telecommunications network to support the deployment of a variety of services and network slices. Compute resources are required for the core network (i.e., mostly for processing of the user plane in the UPF), in some embodiments, and are allocated as a function of the quantity of traffic processed, with one CPU core required per 5 Gbps of traffic. As the MEC is used to support deployment of third party services, according to some embodiments, the amount of resources required depends on the types of applications supported. Examples of application types, in some embodiments, include caching or Content Distribution Networks (CDN), Intelligent Transportation Systems (ITS), Internet of Things (IoT), and cloud gaming.

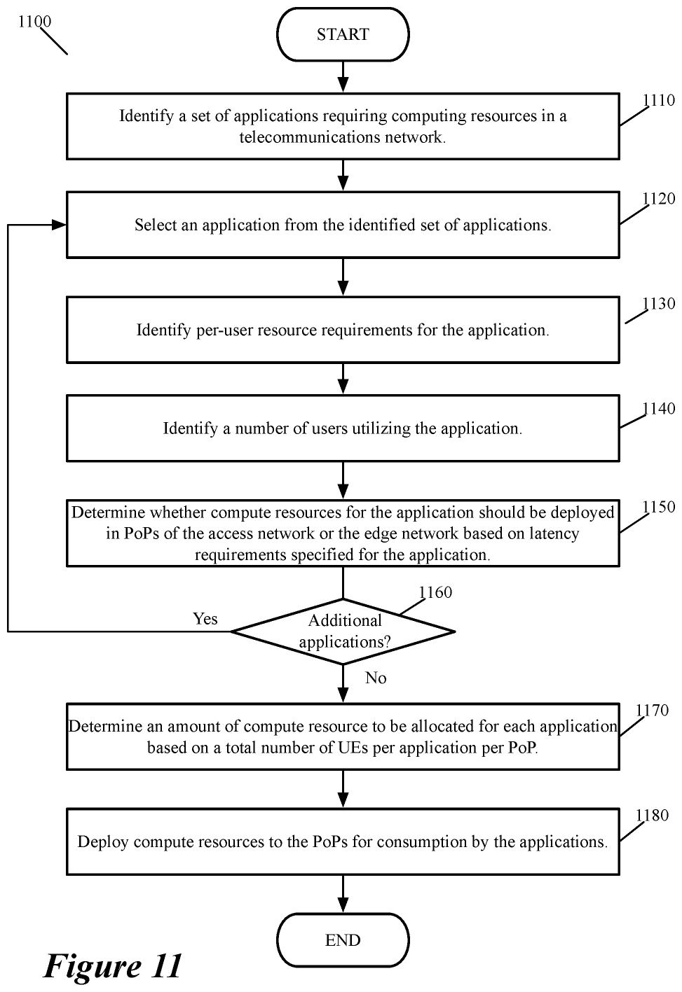

FIG. 11 conceptually illustrates a process of some embodiments for deploying computing resources for a telecommunications network. The process 1100, like the process 400, is performed in some embodiments by a network administrator and one or more algorithms. The process 1100 starts by identifying (at 1110) a set of applications requiring computing resources in a telecommunications network.

The process 1100 selects (at 1120) an application from the identified set of applications and identifies (at 1130) per-user resource requirements for the application. For example, for an ITS application, some embodiments require one vCPU (virtual CPU) per ten (10) cars. In another example, a particular server may be specified to support 150 users for a cloud gaming application. In some embodiments, the per-user resource requirements may be identified by obtaining data from providers of the applications.

The process 1100 identifies (at 1140) a number of users utilizing the application. In some embodiments, the number of users that utilize an application is identified based on breakdowns of service usage obtained from outside sources, and based on estimates of the number of UEs per access node that use the service. All or part of the process 900 is used, in some embodiments, to estimate the number of UEs per access node that use the service.

The process determines (at 1150) whether compute resources for the application should be deployed in PoPs of the access network or the edge network based on latency requirements specified for the application. Access ring PoPs have low latency, while edge ring PoPs have no latency constraints, according to some embodiments. Compute resources for a CDN service, for example, should be deployed to access ring PoPs to allow the CDN service to cache content close to the user and reduce latency for the user's request. In addition to the reduction in latency, bandwidth demands toward the core network would also be reduced as a result of the CDN service's compute resources being deployed to access ring PoPs, according to some embodiments.

ITS services have tight latency requirements (e.g., 5-100 ms) as these applications provide information to vehicles, support smart junctions, autonomous driving, etc., according to some embodiments. As such, these applications and their resources must be situated close to the UEs, in the access ring, either in an FCP or PoP. IoT services are considered to have less stringent latency requirements, in some embodiments, and as a result, they can be deployed anywhere in the telecommunications infrastructure. In cloud gaming, rendering of in-game content is done on cloud servers which then send the content as video files to the device, enabling low performance devices to play high quality games, according to some embodiments. In some such embodiments, latency is critical, with requirements for <50 ms, in some embodiments, which restricts deployment to the access ring.

The process determines (at 1160) whether there are additional applications in the set requiring compute resources. When the process determines there are additional applications in the set, the process returns to 1120 to select an application from the set. Otherwise, when the process determines there are no additional applications in the set, the process 1100 transitions to determine (at 1170) an amount of compute resource to be allocated based on a total number of UEs per application per PoP.

For a CDN service, for example, according to the MetroHaul project, one instance of 22.5 TB is deployed per access network, and one of 11.25 TB per edge network, as well as 4 vCPUs at the access and 5 vCPUs at the edge. For ITS services, the MetroHaul project recommends 1 vCPU per 10 cars. From the FANTASTIC-5G project, a density of 100 cars per RU is derived, furthermore reduced to 10 per RU assuming that only 10% of cars will use the ITS services. As such there will be 400 cars per access ring FCP (40 vCPUs) or 1600 for the PoP (160 vCPUs). In some embodiments, IoT services provide data pre-processing, analytics, warehousing, synchronization, etc. for IoT applications, such as smart metering or smart cities. In the case of smart metering, for example, a density of 5000 houses per cell is assumed in MetroHaul. For each house a traffic of 1 Kb per minute is assumed, so 100 kbps per cell. A single vCPU is considered sufficient for processing 100 messages per second, which results in 1 vCPU per RU, so 160 vCPUs at an access PoP or 800 vCPUs at the edge. An example of a GPU solution for cloud gaming is the NVIDIA RTX server that has 40 GPUs and can support 160 users. Based on UE density from FANTASTIC-5G and the traffic model from METIS-I, the average number of UEs engaging in mobile traffic in a cell is assumed to be 16. This leads to 2560 UEs at an access PoP, which would require 16 NVIDIA RTX server, rounded up to 20.

Finally, the process 1100 deploys (at 1180) computing resources to the PoPs for consumption by the applications. Based on the above described examples, the final allocation of compute resources would be (1) 100 vCPUs at 50% of FCPs in each access ring for ITS and IoT use cases, with only those FCPs connecting aggregated gNBs over NGC (i.e., to be able to process application traffic); (2) 400 vCPUs at 50% of PoPs in each access ring for ITS and IoT use cases; (3) 20 NVIDIA RTX servers at 50% of PoPs in each access ring; (4) 25 TB storage at one access PoP per access ring as primary CDN storage; (5) 1000 vCPUs and 100 TB storage at one edge PoP per edge ring for IoT data warehousing and video cache; and (6) one core per 5 Gbps of traffic in the core datacenter. Following 1180, the process 1100 ends.

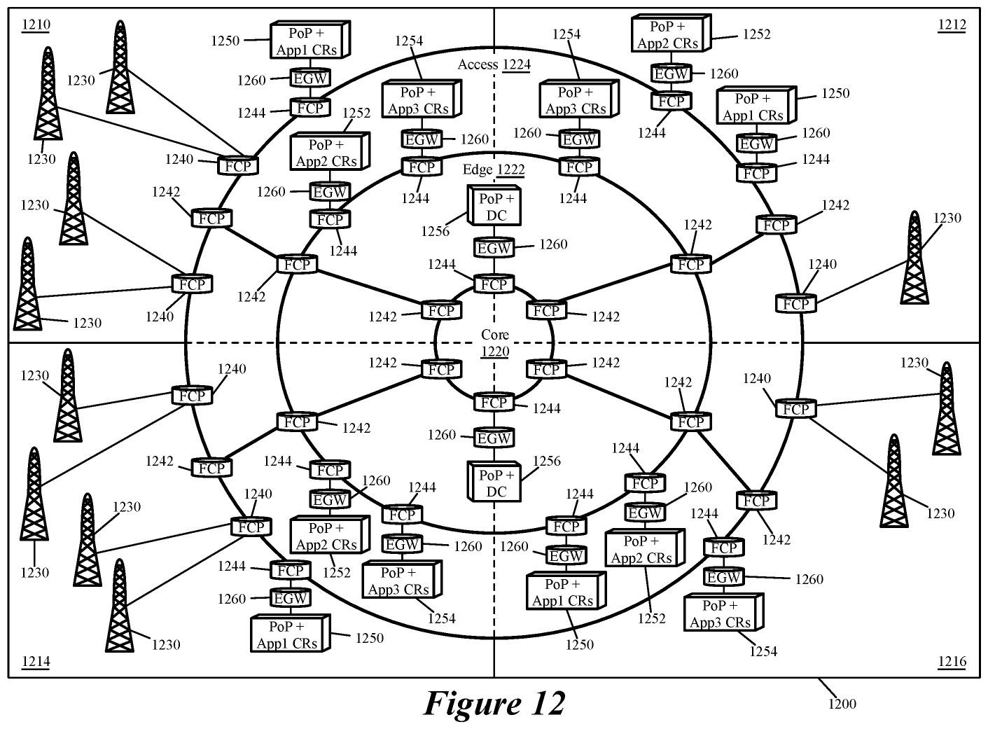

In some embodiments, the process 1100 is performed for each cell in the grid used to divide a geographic area. As a result, in some embodiments, configurations of components of the access and edge networks for a telecommunications network may vary from cell to cell based on the environment within each cell. FIG. 12 conceptually illustrates a diagram 1200 for a geographic area of some embodiments covered by a telecommunications network and divided into four cells, with each cell having a different configuration of the access and edge networks. As shown, the diagram 1200 includes a core network 1220, an edge network 1222, and an access network 1224 covering each of the cells 1210, 1212, 1214, and 1216.

Access nodes 1230 are deployed in each cell 1210-1216 and connect to the access network 1224 via respective FCPs 1240. In this example, the cell 1210 includes four access nodes (e.g., base stations) 1230, the cell 1212 includes one access node 1230, the cell 1214 includes four access nodes 1230, and the cell 1216 includes two access nodes 1230. Additionally, in each cell 1210-1216, FCPs 1242 connect the access network 1224 to the edge network 1222, and the edge network 1222 to the core network 1220, as shown.

In addition to the FCPs 1240 and 1242, each of the core, edge, and access networks 1220-1224 includes FCPs 1244 for connecting to PoPs via edge gateways 1260. The PoPs include PoPs 1250 in which compute resources for a first application are deployed, PoPs 1252 in which compute resources for a second application area deployed, and PoPs 1254 in which compute resources for a third application are deployed. While illustrated as being deployed to separate PoPs for the sake of simplicity and clarity in the diagram 1200, the compute resources deployed for different applications in other embodiments may be deployed to the same PoPs (i.e., compute resources for multiple applications may be deployed to the same PoP).

Each cell 1210-1216 includes compute resources deployed for each of the first, second, and third applications. However, the deployment of these resources varies from cell to cell. In the cells 1210 and 1214, the compute resources for the first application are deployed to PoPs 1250 in the access network 1224, and the compute resources for the second and third applications deployed to respective PoPs 1252 and 1254 in the edge network 1222. In the cell 1212, resources for the first and second applications are deployed to PoPs 1250 and 1252 in the access network 1224, and compute resources for the third application are deployed to a PoP 1254 in the edge network 1222. Lastly, in the cell 1216, compute resources for the first and second applications are deployed to PoPs 1250 and 1252 in the edge network 1222, and compute resources for the third application are deployed to a PoP 1254 in the access network 1224. In addition to the compute resources deployed to PoPs in the access and edge networks, FCPs 1244 in the core network 1220 connect to PoPs 1256 (via edge gateways 1260) that host datacenters that include resources for the core network and for services provides to end-users.

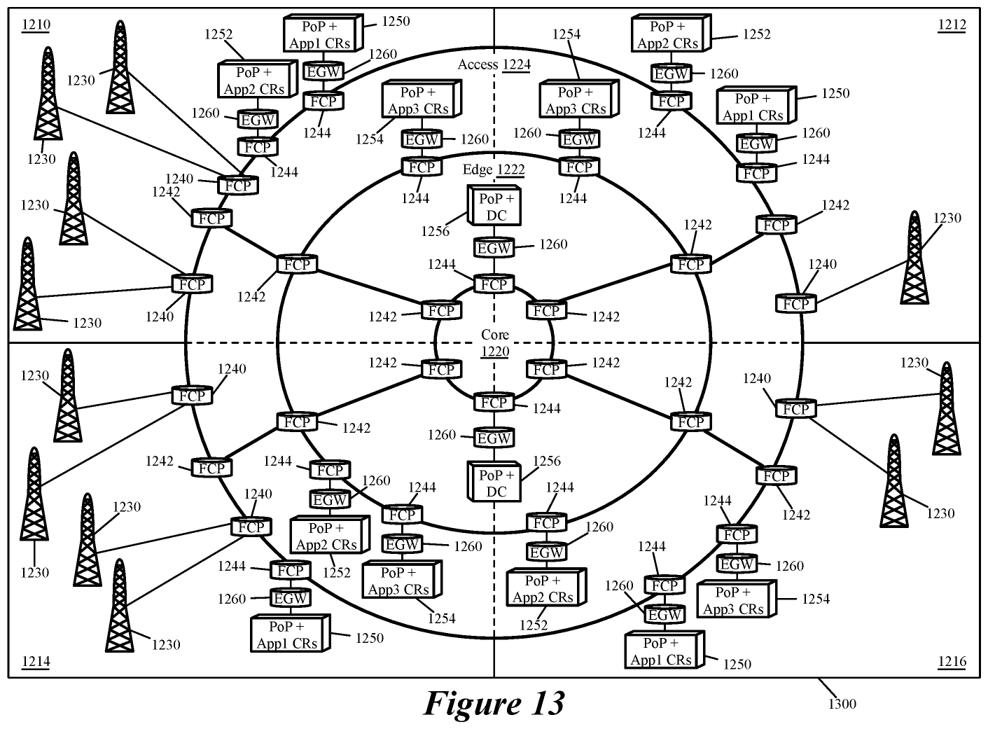

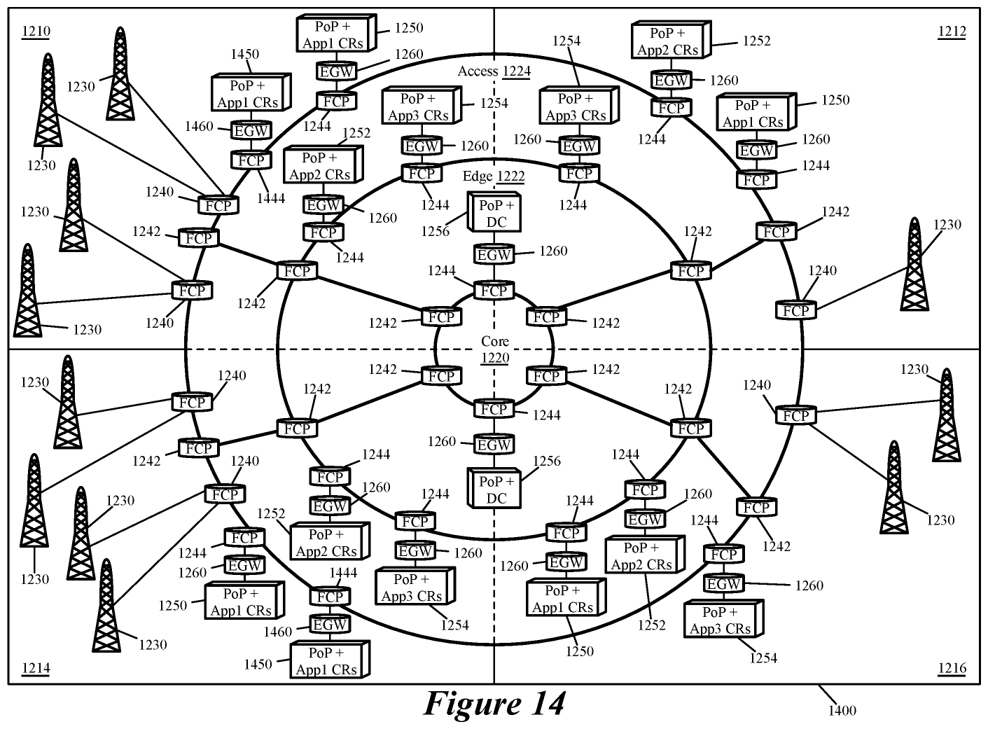

In some embodiments, a following a simulation of the performance of components of the telecommunications network, modifications to the deployment of compute resources may be made, as also described above. For example, FIGS. 13 and 14 conceptually illustrate respective diagrams 1300 and 1400 after modifications to compute resource deployments for the cells 1210-1216 have been made.

In the diagram 1300, the compute resources deployed for the first application in the cell 1216, which were deployed to a PoP in the edge ring 1222, have been instead deployed in the access ring 1224, as shown. Additionally, for the first cell 1210, the compute resources deployed for the second application have been deployed in the access network 1224 in the diagram 1300 as opposed to the edge network 1222 to which they were deployed in the diagram 1200. While the example diagram 1300 illustrates the FCPs, edge gateways, and PoPs with the compute resources being moved from one network to another (i.e., edge to access network) for the sake of clarity, modified deployments of other embodiments may simply deploy the compute resources to existing PoPs in the respective edge or access networks.

In some embodiments, the modifications to compute resource deployments can include deploying additional resources for the applications. The diagram 1400, for example, includes deployments of additional compute resources. Specifically, cells 1210 and 1214 now include additional compute resources for the first applications deployed to PoPs 1450, which connect via edge gateways 1460 to FCPs 1444 in the access network 1224. In some embodiments, the additional compute resources are deployed to the same PoPs as current resource deployments, while in other embodiments, additional compute resources are deployed to different PoPs than the current resources. The PoPs, according to some embodiments, host MECs to which the compute resources are deployed for consumption by applications (e.g., non-telephony applications provided by a third party, such as IoT applications, ITS applications, cloud gaming applications, and caching applications) that provide services to end-users of the telecommunications network.

In some embodiments, the modifications to compute resource deployments, as well as initial compute resource deployments, are determined by simulating performance of the telecommunications network using an infrastructure generator as described above. The 5G infrastructure generator of some embodiments may be implemented in Python and open-sourced, and generate the infrastructure as a NetworkX graph, where the nodes are either compute nodes or access nodes. The compute nodes (‘type’=‘pop’) attributes, in some such embodiments, indicate availability of compute resources: ‘cores’, ‘storage’, ‘gpus’, and ‘traffic’, with the latter representing the ingress data rate. The access nodes (‘type’=‘sap’) attributes record the Tracking Areas (‘tas’) associated to the node, as well as the input and output traffic rate, according to some embodiments. The edges of the graph, in some embodiments, represent TN links with ‘capacity’ in Mbps and ‘latency’ in milliseconds.

In one use-case example for the telecommunications infrastructure generator described above, relevant algorithms may be evaluated. For instance, a generated telecommunications infrastructure can be used for the evaluation of a network slicing algorithm, such as the Service Graph Embedding (SGE) algorithm based on the work of Nemeth et al. (Nemeth, B, et al. Efficient service graph embedding: A practical approach. In 2016 IEEE Conference on Network Function Virtualization and Software Defined Networks (NFV-SDN), pages 19-25. IEEE, 2016). The service implemented in the network slice is represented as a service graph where data is received at Service Access Points (SAPs) and is processed in chains of Network Functions (NFs) that may or may not intersect. This representation is generic such that it may be representative of any communication service. The Nemeth et al. algorithm starts by mapping the SAPs to infrastructure nodes, since the SAPs correspond to cells or Tracking Areas in the infrastructure. Then the service graph is divided into disjoint subchains, which are sorted in order of their distance from the SAPs (predecessor criterion) and of end-to-end delay. The algorithm proceeds to map the sorted service subchains onto the infrastructure, one edge at a time, selecting from a set of k-shortest paths the one that minimizes a composite metric of bandwidth, delay, and resource utilization. The algorithm backtracks in case no candidate paths are available for a leg of a service subchain.

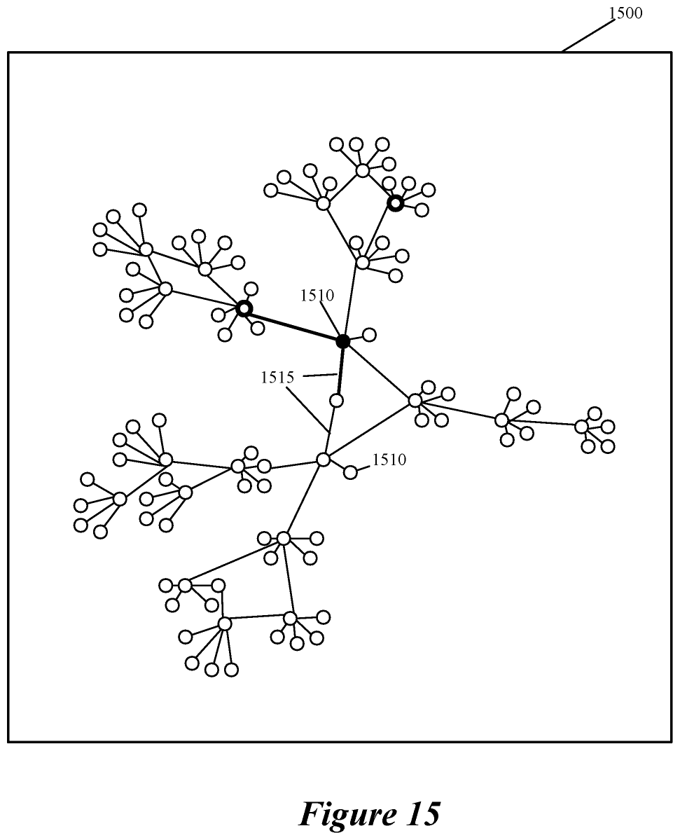

When evaluating network resource allocation algorithms, in some embodiments, it is important to consider the impact of the configuration of the service graphs used as input, as well as that of the configuration of the infrastructure graph. For the former, an algorithm was implemented to generate service graphs containing multiple service chains as well as various numbers of inputs and outputs. Using a generated 5G infrastructure as input infrastructure, some embodiments can test the SGE algorithm with 500 consecutive service graph embedding requests, adding each successful embedding to the infrastructure. The embedding is stopped, in some embodiments, when ten (10) consecutive failures to embed are recorded. FIG. 15 illustrates an example of the generated 5G infrastructure (without the access nodes) with the intensity (i.e., boldness) of the nodes and edges representing the remaining resources after the embedding completed. The dark nodes in the center of the infrastructure 1500 are a core and an edge datacenter 1510 that, along with some of the links 1515 that join them, have fully utilized their resources. Because the 5G infrastructure is hierarchical, resources will be allocated at the closest point between the TAs selected as SAPs. When the SAPs are randomly distributed throughout all TAs, the closest point will most times be at the center of the network.

In some embodiments, evaluations of network resource allocation algorithms are performed on a range of input infrastructures like the infrastructure 1500. Infrastructures of some embodiments may be too permissive and lead to optimistic results, while others may contain bottlenecks that lead to the worst cases. The embodiments described herein provide randomness in the form of two random processes. Namely, the deployment of computation resources, and the deployment of population density functions. The deployment of computation resources uses a fixed infrastructure but randomizes the deployment of compute resources between the nodes. The deployment of population density functions leads to a randomized number and location for access nodes, which in turn leads to a randomized infrastructure.

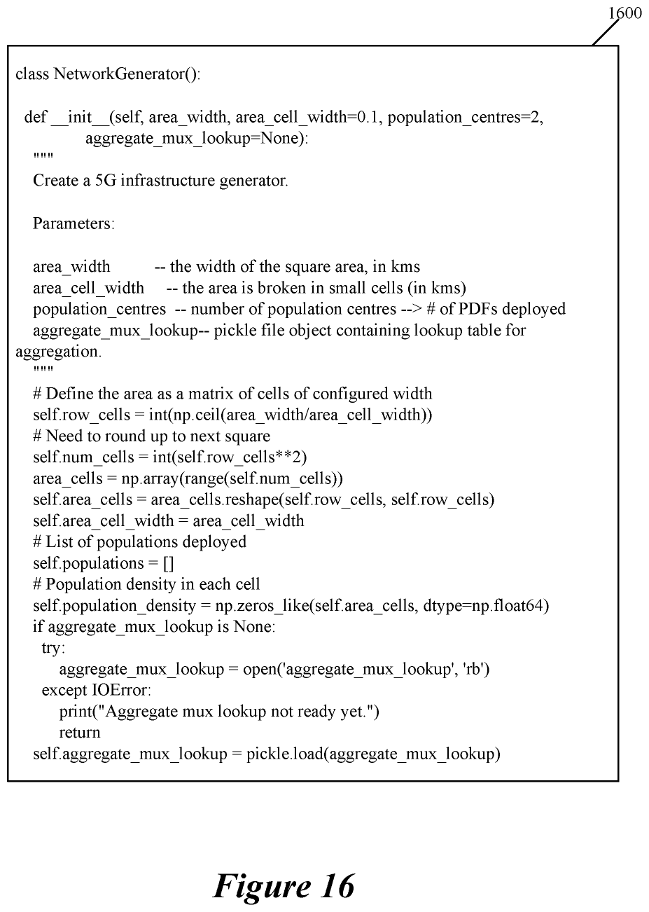

FIG. 16, for instance, illustrates a set of code 1600 for generating a network infrastructure. As shown, the code 1600 includes parameters for a geographic area to be covered by the telecommunications network, parameters for the cells that the geographic area is split into (e.g., using a grid), and parameters defining population density. The parameters defining population density include a list of the population deployed, and population density for each cell of the geographic area, as shown.

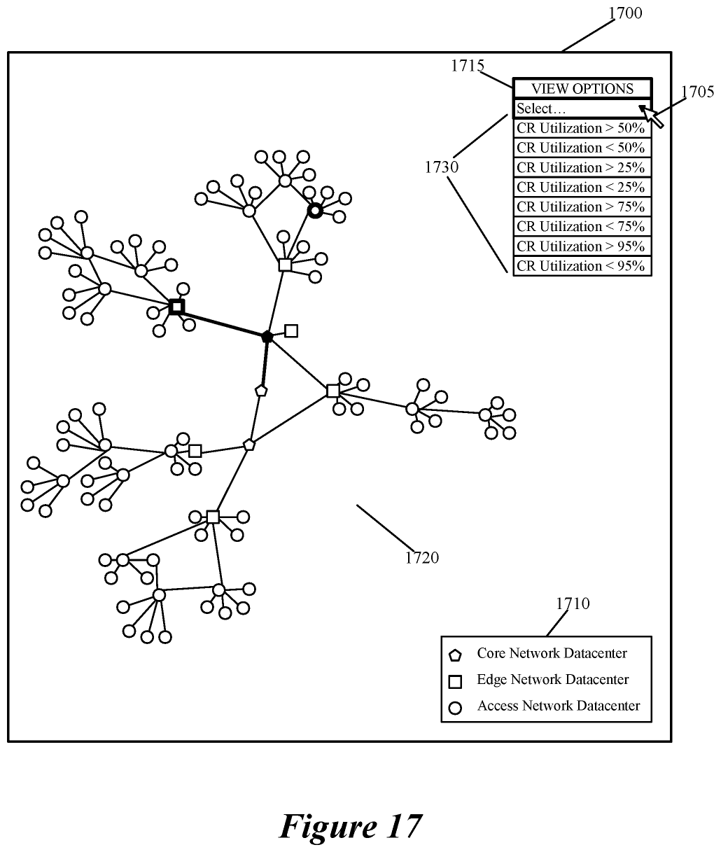

In some embodiments, the infrastructure 1500 is displayed through an interactive UI that enables a user (e.g., network administrator) to simulate and modify various deployments of a telecommunications network. FIG. 17 conceptually illustrates an example of an interactive UI provided by some embodiments for viewing, analyzing, and modifying various deployments for telecommunications networks. In this example, the UI 1700 includes a graph 1720 of nodes and edges representing a particular network deployment of some embodiments, a key 1710 identifying various node types in the graph 1720, and a set of view options 1715 for identifying datacenters (and MECs) of various compute resource utilizations.

Users of the UI 1700 can provide input to affect the display using a variety of different input devices, according to some embodiments. In the UI 1700, a cursor 1705 is illustrated as selecting the dropdown option in the view options 1715, revealing selectable items 1730 that, upon selection, can alter the graph 1720. The input devices of some embodiments can also include alphanumeric keyboards and other pointing devices (also called “cursor control devices”). In addition to input devices, embodiments also include output devices for displaying images generated by the computer system that provides the UI. The output devices of some embodiments include printers and display devices, such as cathode ray tubes (CRT) or liquid crystal displays (LCD). Some embodiments include devices such as touchscreens that function as both input and output devices.

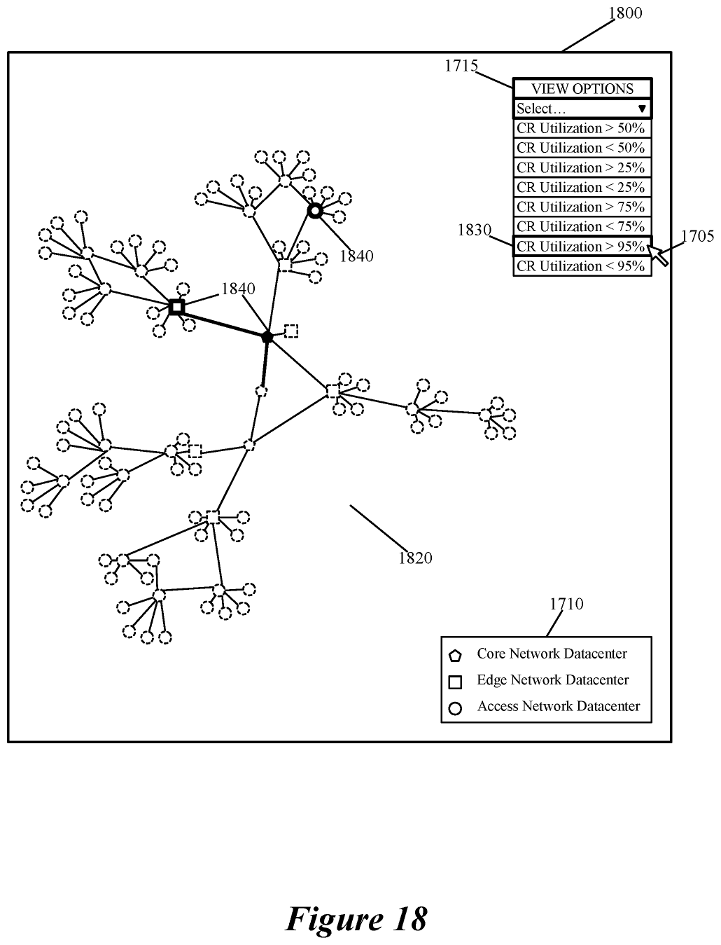

FIG. 18 illustrates the UI after a user has selected a view option from the dropdown menu, in some embodiments. As shown, the cursor 1705 has selected the option 1830 to view datacenters (or MECs) with compute resource utilization greater than 95% in the UI 1800. As a result of this selection, most of the nodes in the graph 1820 appear with dashed outlines, while three nodes 1840 retain solid outlines to indicate the datacenters (or MECs) represented by these nodes have compute resource utilizations above 95%. It should be noted that other embodiments of the invention may represent nodes in the graph 1820 differently than illustrated, such as by using different colors to differentiate between various nodes in the graph. Additionally, while the nodes representing core network datacenters, edge network datacenters, and access network datacenters each have a unique appearance (i.e., different shapes), other embodiments of the invention may represent each datacenter using the same appearance, or differentiate between the datacenters using another means (e.g., size, outline strength, color, etc.).

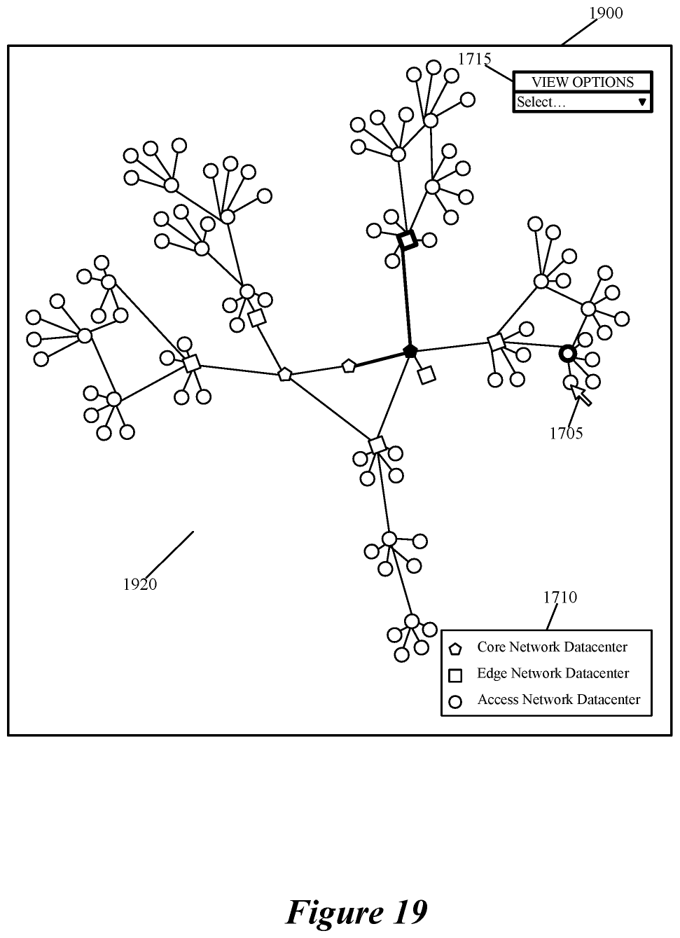

In some embodiments, as illustrated by FIG. 19, input devices, such as the cursor 1705, can be used to grab and move objects displayed in the UI. As shown, the cursor 1705 has been used to grab and drag the graph 1920 to rotate the graph and change its orientation. In addition to repositioning the graph 1920, the graph also appears larger (i.e., zoomed in). Various gestures using input devices, such as a mouse or touchscreen, are used, in some embodiments, to modify how the graph is viewed through the UI 1900. In other embodiments, gestures for viewing a particular portion of the graph (e.g., a single edge datacenter and each of the access datacenters connected to the single edge datacenter), or other viewings of the graph, may be utilized.

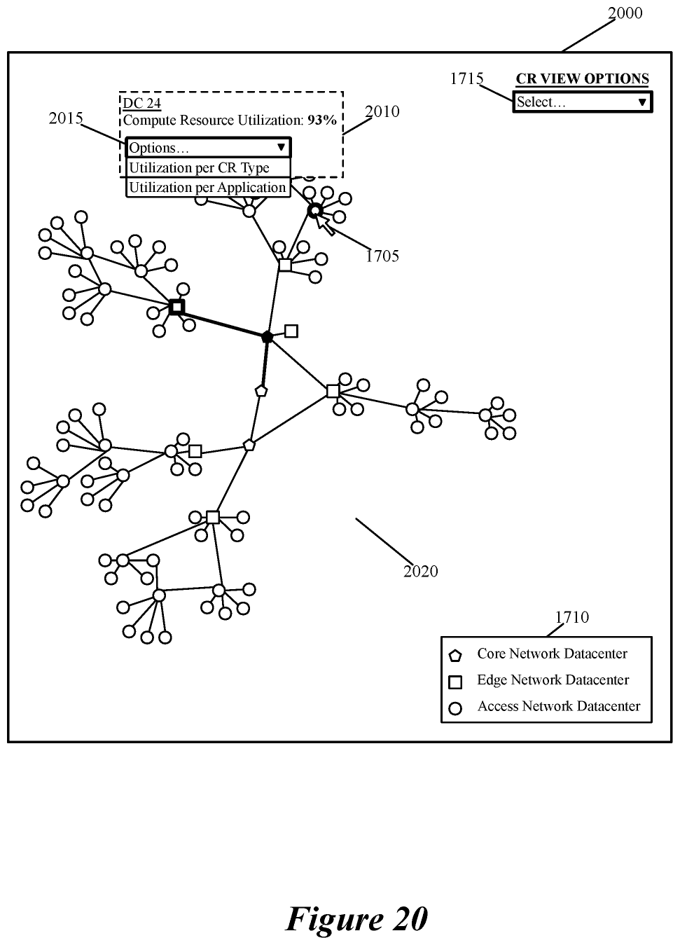

FIG. 20 illustrates the UI after the cursor is used to select (e.g., by clicking, hovering, or otherwise gesturing with the cursor 1705) a particular node in the graph 2020, in some embodiments. As a result of the selection, a pop-up window 2010 now appears in the UI 2000 near the selected node. The window 2010 identifies the datacenter represented by the selected node as “DC 24”, as well as indicating a compute resource utilization of 93% by the datacenter “DC 24”. Additionally, the window 2010 includes a dropdown menu 2015 that includes options for viewing utilization per type of compute resource (e.g., storage resources, core resources, etc.), or viewing utilization broken down by application (e.g., non-telephony applications such as cloud gaming applications). It should be noted that the options illustrated for the dropdown menu 2015 are exemplary, and other embodiments may include any variety of view options including or instead of those shown (e.g., options to view other data related to the selected datacenter).

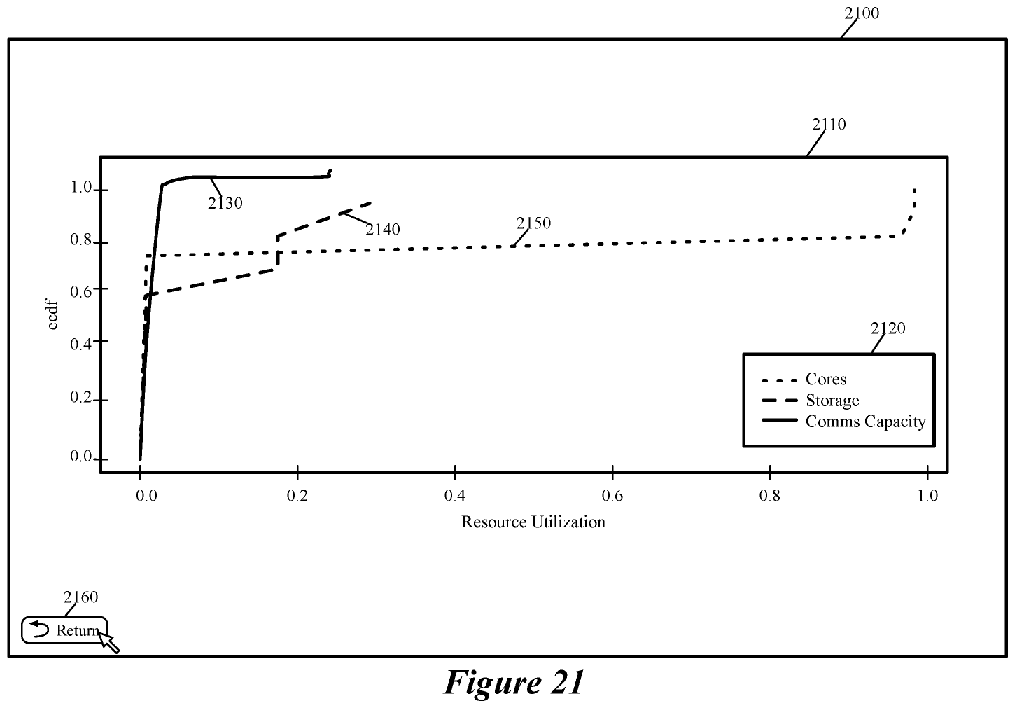

In some embodiments, selecting an option from a dropdown menu such as the dropdown menu 2015 causes a new view to be displayed through the UI. For instance, FIG. 21 illustrates the UI after the option to view utilization broken down by compute resource type, in some embodiments. As shown, the UI 2100 includes a graph 2110 indicating resource utilization for core resources (e.g., CPUs), storage resources, and communications capacity (i.e., strength of coverage and reach of communications) using an empirical cumulative distribution function (eCDF), which is a distribution function associated with an empirical measure of a sample (e.g., a sample of performance metrics associated with one or more components telecommunications network). The eCDF is a step function that steps up by “1/n” at each of “n” data points and for which the value at any specified value of the measured variable (e.g., resource utilization) is equal to the fraction of observations of the measured variable that are less than or equal to the specified value.

The graph 2110 includes a key 2120 indicating which line types correspond to which resources in the graph, with lines corresponding to core utilization 2150, storage utilization 2140, and communications capacity utilization 2130. Based on the graph 2110, it can be deduced that the CPU resources (i.e., cores) are causing a bottleneck. In some embodiments, additional UI items for modifying compute resource deployment from the display in the UI 2100 are also included, while in other embodiments, modifications are made from the infrastructure graph views, which can be returned to using a UI item such as the return button 2160 as shown. Also, in some embodiments, the graph 2110 is displayed as a pop-up window, like the pop-up window 2010, rather than having its own display window.

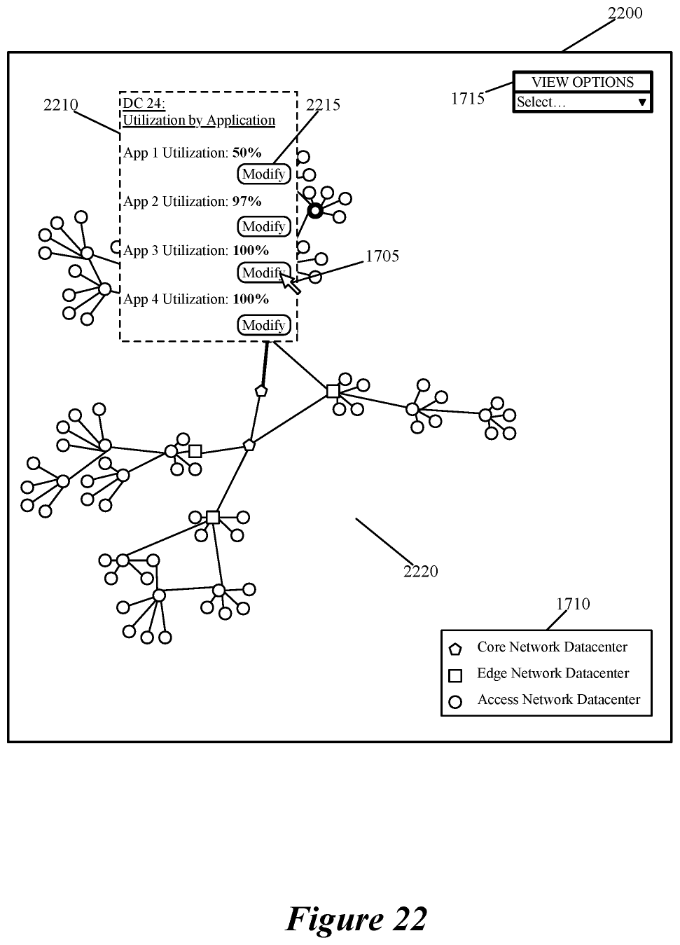

FIG. 22 illustrates the UI of some embodiments after a different option has been selected in the pop-up window from FIG. 20. The UI 2200 now includes a pop-up window 2210 that indicates utilization by application for the datacenter “DC 24”. In this example, compute resource utilization is listed for four applications, with application 1 at 50% compute resource utilization, application 2 at 97% compute resource utilization, and applications 3 and 4 each at 100% compute resource utilization. Also, for each application listed, the window 2210 includes a respective “modify” button 2215 to allow users of the UI 2200 to modify the compute resource allocation for each application if desired.

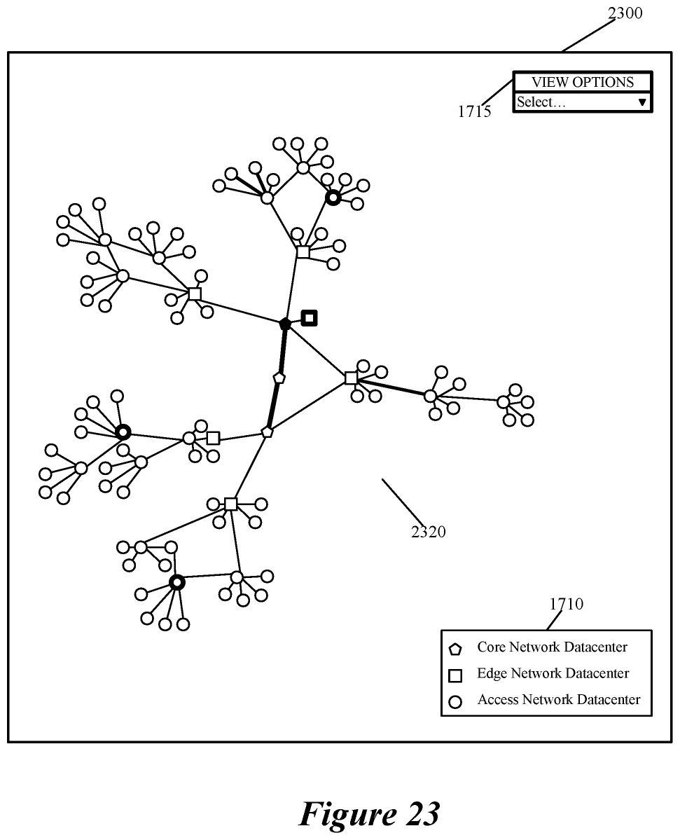

FIG. 23 illustrates the UI of some embodiments after modifications to compute resource deployments have been made. In this example, indications of compute resource utilization differ from the graphs illustrated by the examples described above, with some datacenters (or MECs) and edges in the graph 2320 having increased utilization, and others having decreased utilization. In some embodiments, the changes in utilization may also be due to changes in behavior by end-users (e.g., an increased or decreased number of end-users in a particular region). In some such embodiments, these changes may be based on real-time data for a particular region, or based on estimates and predictions for future behavior (e.g., an upcoming event, such as a convention, for which end-user numbers are expected to significantly increase for a region).

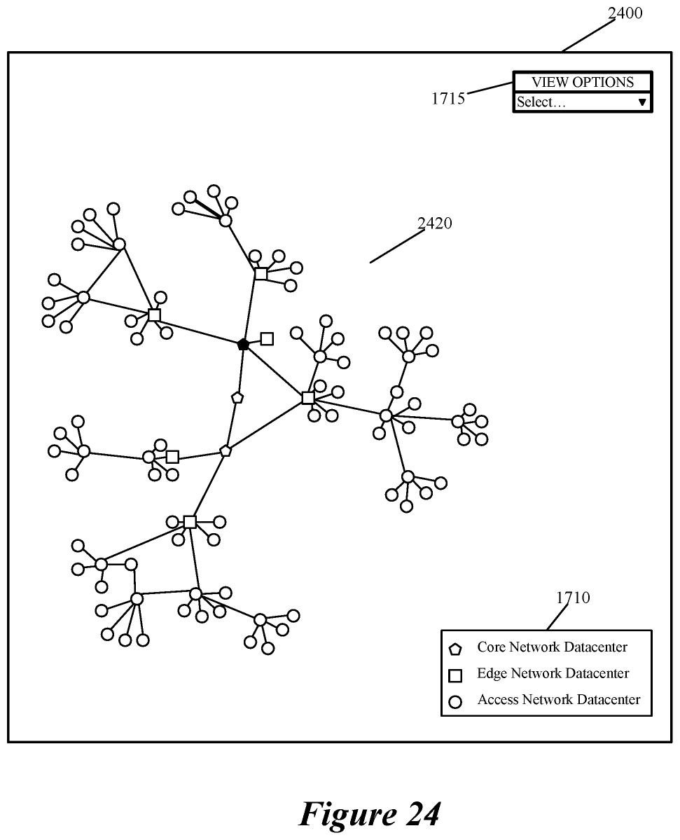

In some embodiments, in addition to, or instead of modifying compute resource deployments, modifications to the infrastructure configuration are also made to improve performance. FIG. 24 illustrates the UI of some embodiments after modifications to compute resource deployments and infrastructure deployments have been made. The UI 2400 displays an infrastructure graph 2420 that includes different amounts of core, edge, and access network datacenters than the example infrastructure graphs described above. Additionally, there are fewer edges and datacenters in the graph 2420 that indicate high compute resource utilization. While modifications to the infrastructure and compute resource deployments are user-defined in some embodiments, these modifications in other embodiments are a result of one or more algorithms, such as the algorithm used to generate the infrastructure, which provides realistic and random infrastructures, as well as any algorithms evaluated using the generated infrastructures, such as algorithms for defining compute resource deployments.

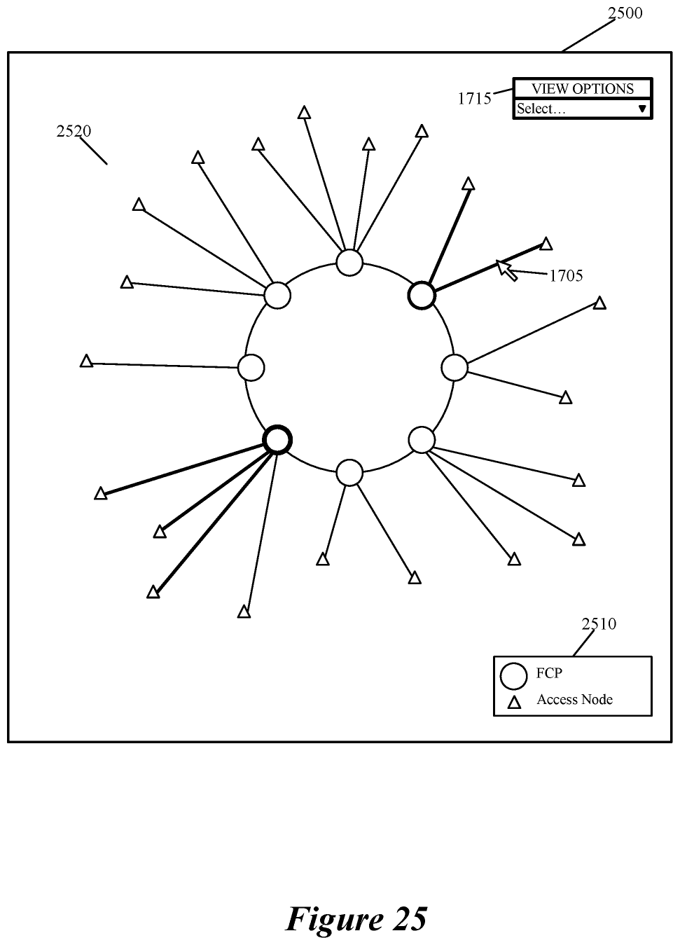

In some embodiments, the UI also provides options for users to view individual parts of a network, such as the access network. FIG. 25 illustrates the UI of some embodiments that displays the access network portion of a telecommunications network. As shown, the UI 2500 includes the view options 1715 as described above, as well as a key 2510 identifying the node types illustrated in the graph 2520. Specifically, the graph 2520 includes multiple access nodes connected via transport links to FCPs of the access network. Like the graphs described above, some nodes and edges in the graph 2520 appear with a bolder outline indicating a higher utilization. In some embodiments, hovering or selecting a node or edge with a cursor 1705 (or other input device) can cause the UI 2500 to alter the display.

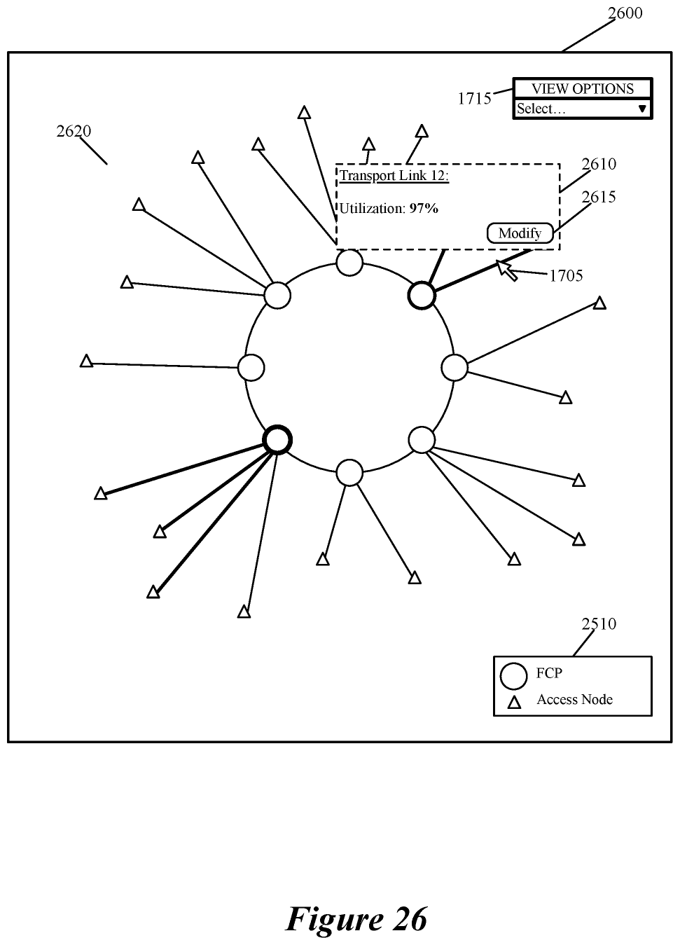

FIG. 26 illustrates the UI of some embodiments when a user selects a representation of a transport link. As shown, the cursor 1705 has selected a transport link in the graph 2620, causing the UI 2600 to display a pop-up window 2610 that identifies the link as transport link 12, and indicates the transport link's utilization is 97%. In some embodiments, this is an indication that the number of end-users (e.g., UEs), or the amount of traffic generated by the end-users, relying on this link to access the telecommunications network has become too high, causing a bottleneck for the link and the FCP to which it connects. As such, the window 2610 also includes a button 2615 for modifying the capacity of the transport link. In some embodiments, the UI 2600 also allows users to modify the transport link deployment as a whole, such as for the purpose of adding links, or updating links.

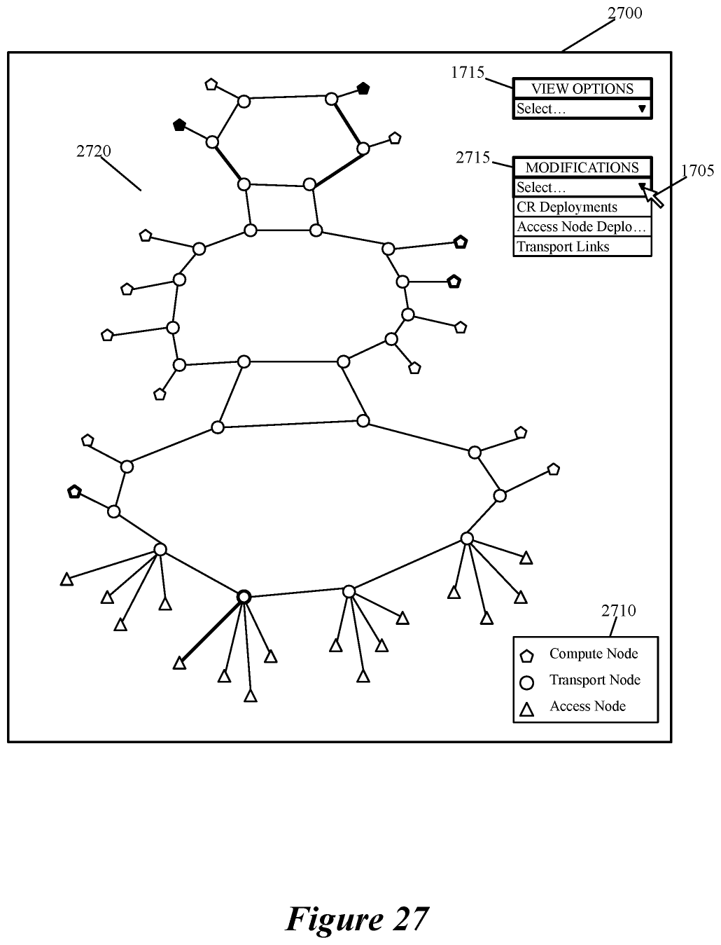

In some embodiments, a user can also view the access, edge, and core network deployments and their components. FIG. 27 illustrates the UI of some embodiments that displays the access, edge, and core network deployments and their components. As shown, the UI 2700 includes the view options 1715, an infrastructure graph 2720, a key 2710 identifying the node types in the graph 2720, and a second dropdown menu 2715 with selectable modification options. Using the graph 2720, a user can identify areas of congestion, and other network issues, for each of the access, edge, and core network deployments. It should be noted that while the example UIs described herein illustrate node and edge graphs, other embodiments may display other visualizations of the telecommunications network, such as visualizations that look like the diagrams in FIGS. 12, 13, and 14. Additionally, the UI items described and illustrated in the examples above are merely exemplary and other embodiments of the invention may have more, fewer, or different UI items than those described above and illustrated in the corresponding figures.

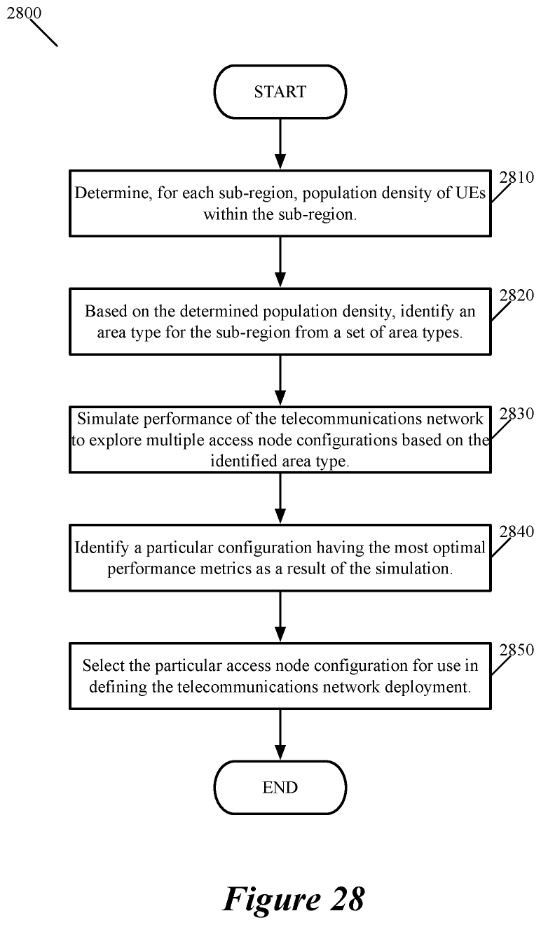

FIG. 28 conceptually illustrates a process of some embodiments for defining access node deployments for a telecommunications network. The process is performed in some embodiments by a function or set of functions implemented in a computer system. The process 2800 starts by determining (at 2810), for each sub-region within a particular geographic region, population density of UEs within the sub-region. In some embodiments, the process determines the population density by receiving population density as input. For example, in some embodiments, a user may provide historical population density data for a region, which can be used outright, or used to generate estimates for current and/or future population density.

Based on the determined population density, the process 2800 identifies (at 2820) an area type for the sub-region from a set of area types. As described above, the area types of some embodiments include dense urban, suburban, and rural, with each area type based on a number of UEs in the sub-region. In some embodiments, additional attributes may be used when selecting area type for a sub-region. For example, a rural area in some embodiments may have a high-traffic roadway on which many UEs travel, thereby resulting in a higher UE density for the sub-region. In some such embodiments, the sub-region may be categorized as suburban or dense urban to account for the increased number of UEs resulting from the roadway.

The process 2800 simulates (at 2830) performance of the telecommunications network to explore multiple access node configurations based on the identified area type. The simulation is performed using a network generator algorithm, such as the network generator described above by reference to FIG. 16, in some embodiments. In some embodiments, the simulation includes simulating performance of the entire telecommunications network, while in other embodiments, performance of only a portion (e.g., the access network) is simulated.

In some embodiments, simulating performance of the telecommunications network includes providing one or more sets of input for the network generator algorithm. Each input set, in some embodiments, includes subsets of input identifying specific instances in time for the simulation, as well as specifications describing the environment associated with the geographic area for which the simulation is being performed, such as the population density data, the area type identified at 2820, predicted or simulated locations of UEs throughout the geographic area, and physical measurements for the geographic area. In some embodiments, the input is used by the network generator to generate a variety of templates for access node configurations, and simulating performance to explore the configurations includes simulating performance for each of the generated templates.

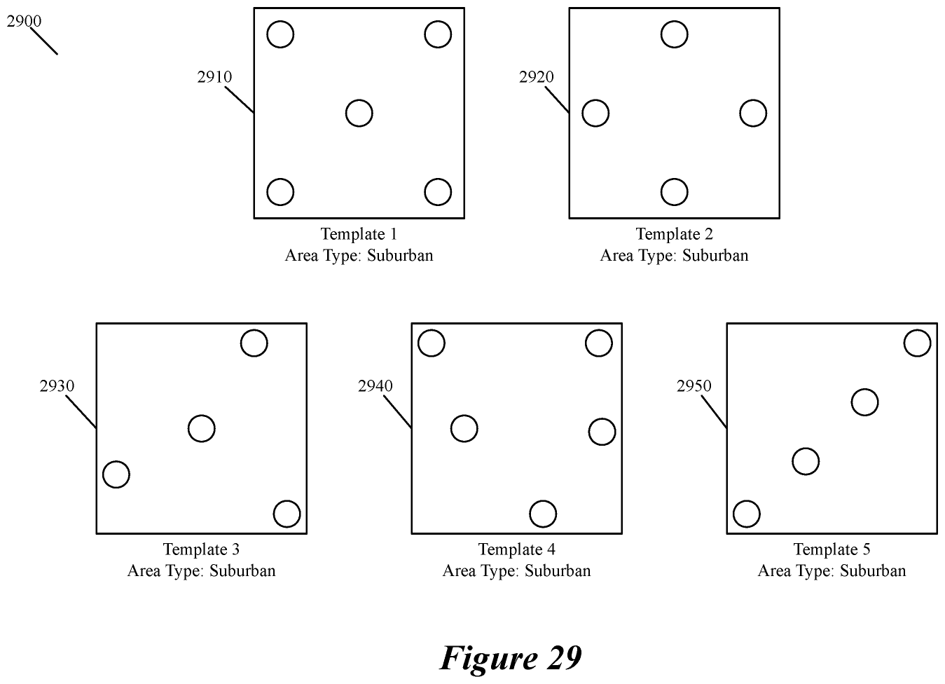

Alternatively, or conjunctively, in some embodiments, the input includes pre-defined templates specifying access node configurations for use in the simulations. For instance, FIG. 29 conceptually illustrates a set of example templates that are pre-defined for suburban area types, in some embodiments. As illustrated, the set of templates 2900 includes a first template 2910, a second template 2920, a third template 2930, a fourth template 2940, ad a fifth template 2950, with each template 2910-2950 having four or five access nodes in a different configuration. During step 2830, simulations are performed using each of the templates 2910-2950, according to some embodiments.

The process 2800 identifies (at 2840) a particular configuration having the most optimal performance metrics as a result of the simulation. In some embodiments, the most optimal output metrics are determined by comparing the output metrics to performance thresholds specified for the telecommunications network. In other embodiments, output metrics resulting from a variety of simulations are compared to each other to identify which configuration has the most optimal metrics. For example, each of the templates in the set 2900 is associated with a respective set of output performance metrics. The performance metrics of some embodiments may include latency, throughput, packet drops, and other metrics associated with a user's QoE.

In some embodiments, other factors, such as cost, may be used to identify the particular configuration having the most optimal performance metrics. For instance, before factoring in costs, the first template 2910 in the set of templates 2900 may be associated with the most optimal metrics, while the second template 2920 may be associated with the second most optimal metrics. After costs have been factored in, the second template 2920 may be identified as the template with the most optimal metrics due to having a similar location configuration as the first template 2910 while also requiring fewer access nodes, and thus having a lower associated cost.

The process 2800 selects (at 2850) the particular access node and transport link configuration for use in defining the telecommunications network deployment. That is, once the most optimal metrics are identified, some embodiments select the configuration associated with the most optimal metrics for use in defining the telecommunications network. In some embodiments, the configuration details are used to install hardware access nodes (e.g., base stations) in the geographic region for the telecommunications network. Following 2850, the process 2800 ends.

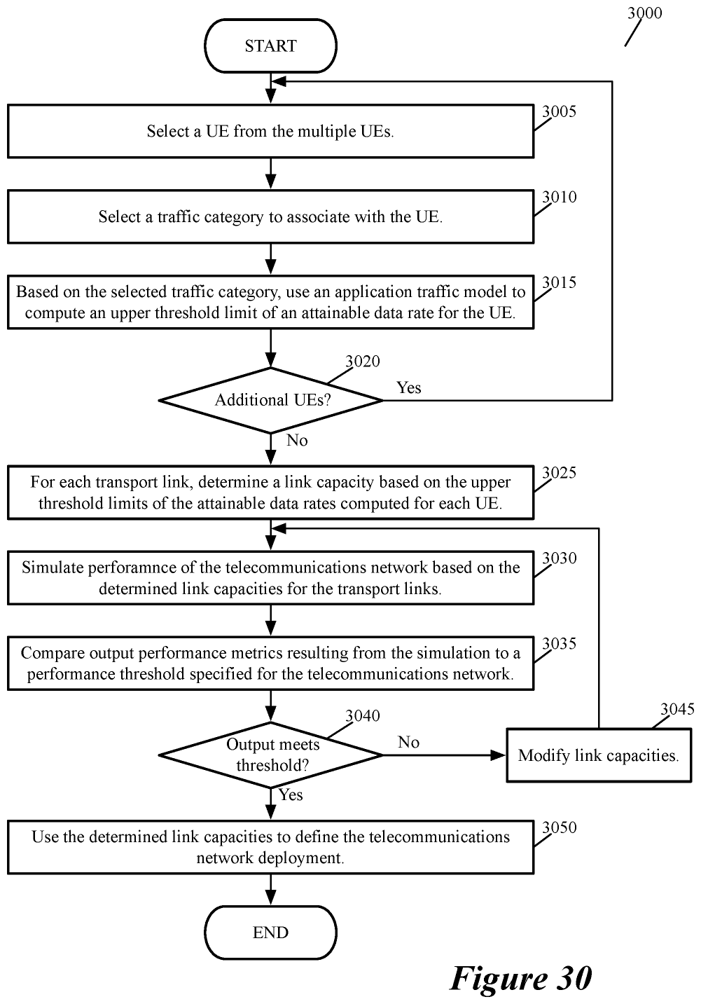

FIG. 30 conceptually illustrates a process of some embodiments for defining transport link deployments for a telecommunications network. The process is performed in some embodiments by a function or set of functions implemented in a computer system. The process 3000 starts by selecting (at 3005) a UE from the multiple UEs. In some embodiments, the UEs are a sample set of UEs for a particular region in which the telecommunications network is currently deployed, or in which the telecommunications network is to be deployed.

The process 3000 selects (at 3010) a traffic category to associate with the UE. As described above, the traffic categories of some embodiments are assigned using equal probability. In other embodiments, the traffic categories are assigned based on real metric data associated with the UE population. For instance, in some embodiments, the traffic categories may be assigned based on how much a UE uses a particular application or set of applications.

Based on the selected traffic category, the process 3000 uses (at 3015) an application traffic model to compute an upper threshold limit of an attainable data rate for the UE. As discussed above for the process 900, the application traffic models of some embodiments are generated as follows. For web browsing traffic, in some embodiments, packet sizes follow a lognormal distribution truncated between 100B and 2 MB, μ=25032B, σ=10710B, and reading times (i.e., inter-packet intervals) are exponentially distributed, with μ=30 s. File transfer is based on an NGMN model, in some embodiments, with packet sizes log normally distributed truncated between 1B and 5 MB, μ=2 MB, σ=0.722 MB, and reading time exponentially distributed with μ=180 s. Video streaming, in some embodiments, is based on Deliverable 6.1 of METIS-I, with constant frame size of 1.66M B at an exponentially distributed interval with μ=33 ms.

The process 3000 determines (at 3020) whether there are additional UEs for selection. When there are additional UEs, the process returns to select a UE at 3005. Otherwise, when there are no more UEs, the process transitions to determine (at 3025), for each transport link, a link capacity based on the upper threshold limits of the attainable data rates computed for each UE. In some embodiments, because the peaks of the sub-regions will not occur at the same time, as mentioned above, a statistical model of the aggregated load can be developed, and the link provisioned for, e.g., 95% of the aggregated load.

The process 3000 simulates (at 3030) performance of the telecommunications network based on the determined link capacities for the transport links (i.e., using the determined link capacities as input for the simulation). In some embodiments, steps 3005-3025 are repeated to generate multiple different input sets for the simulation. For instance, in some embodiments, a first input set may be based on a first sample set of UEs while a second input set may be based on a second sample set of UEs, with each sample set resulting in variations in determined link capacities.

Following the simulation, the process 3000 compares (at 3035) output performance metrics resulting from the simulation to a performance threshold specified for the telecommunications network. As mentioned above, steps 3005-3025 are repeated in some embodiments to generate multiple different input sets for the simulation. In some such embodiments, each input set has a corresponding set of output metrics, and each set of output metrics is be compared to the performance threshold. Alternatively, or conjunctively, each set of output metrics is compared to each other set of output metrics to identify the most optimal set of output metrics.

The process then determines (at 3040) whether the output performance metrics meet the performance threshold specified for the telecommunications network. When multiple sets of input are run through the simulation and produce multiple sets of output metrics, the process of some embodiments instead identifies the set of output metrics that are closest to the performance threshold specified for the telecommunications network. In some embodiments, the output metric set that is closest to the performance threshold is the output metric set that is closest to the performance threshold without exceeding that threshold.

When the output metrics do not meet the performance threshold, the process transitions to modify (at 3045) link capacities of the transport links. For instance, in some embodiments when multiple input sets are generated to produce multiple sets of output metrics, and none of the output metric sets are within a specified range of the specified performance threshold, the process modifies the input sets to increase or decrease the output performance metrics in order to fall within the range of the specified threshold. In other embodiments, the process may instead return to 3005 and generate a whole new set of input metrics.

Otherwise, when the output metrics do meet the performance threshold, the process 3000 uses (at 3050) the determined link capacities to define the telecommunications network deployment. In other words, when optimal metrics are identified, the corresponding configurations are used for defining the telecommunications network deployment. Following 3050, the process 3000 ends.

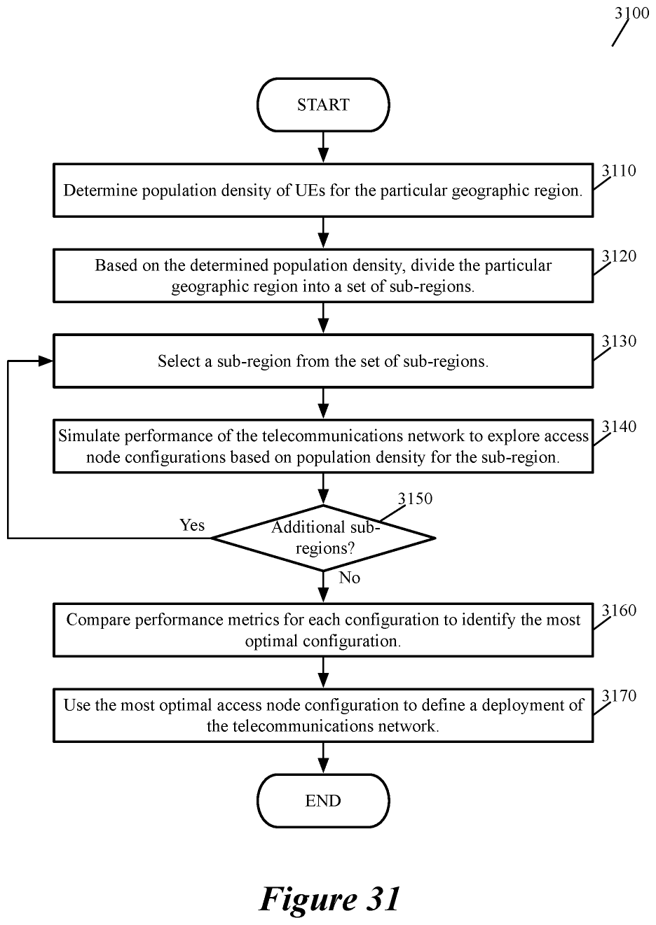

FIG. 31 conceptually illustrates another process of some embodiments for defining access node deployments for a telecommunications network. The process is performed in some embodiments by a function or set of functions implemented in a computer system. The process 3100 starts by determining (at 3110) population density of UEs for the particular geographic region. In some embodiments, the population density of UEs is determined based on any one of, or a combination of, historical population density data, real-time population density data, and estimated population density data (e.g., estimates of current population density, estimates of expected population density, etc.). For instance, in some embodiments, historical population density data (e.g., from a census) is used to generate estimates of current and/or future population density.

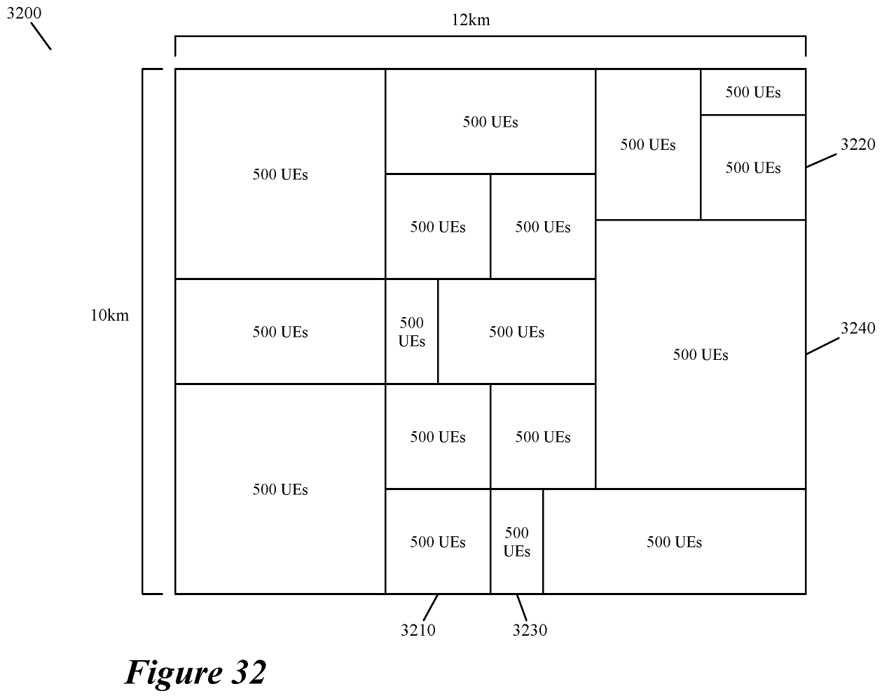

Based on the determined population density, the process 3100 divides (at 3120) the particular geographic region into a set of sub-regions. Unlike some of the embodiments described above, some embodiments divide a geographic region based on the population density such that each cell is a different size, but includes the same number (or relatively same number) of UEs. For example, FIG. 32 conceptually illustrates a particular geographic area of some embodiments that is divided based on population density. As shown, the geographic area 3200 spans an area of 12 km by 10 km that is divided into 17 sub-regions, with each sub-region varying in size and representing 500 UEs (or approximately 500 UEs). For instance, the sub-region 3210 appears to cover the same amount of area as the sub-region 3220, while also covering more area than the sub-region 3230 and less area than the sub-region 3240. While the geographic area 3200 illustrates one manner in which a geographic area can be divided based on population density, other embodiments of the invention may employ other manners of division based on population density.

The process 3100 selects (at 3130) a sub-region from the set of sub-regions and simulates (at 3140) performance of the telecommunications network to explore access node configurations based on population density for the sub-region. For instance, a rural area may be larger than, e.g., a dense urban area, and thus locations of the access nodes may be heavily dependent on where the UEs are located in the sub-region. Using the geographic area 3200 as an example, the access node configurations for sub-regions 3210 and 3220 may include the same number of access nodes, but have different location configurations for their access nodes (e.g., based on where UE density is highest within each sub-region). The sub-regions 3230 and 3240 may also have the same number (or a similar number) of access nodes. However, the access node location configuration for the sub-region 3230 may specify shorter distances between the access nodes that the access node location configuration for the sub-region 3240 due to the sizes of these sub-regions.

In some embodiments, the simulation is performed for the entire geographic area 3200 based on multiple different access node configurations for each sub-region. For example, ten (10) potential configurations may be generated for each sub-region in the geographic area 3200, and the simulation may include simulating each possible combination of potential configurations for each sub-region (i.e., configuration 1 for sub-region 3210 would be run through the simulation for each combination of configurations 1-10 of each other sub-region in the geographic area), resulting in a large amount of output metrics. In other embodiments, the simulation is run for each individual sub-region to determine the best potential configuration for that sub-region, regardless of how the best potential configuration affects the performance of each other sub-region. In still other embodiments, after the best potential configuration is determined for each sub-region, an additional simulation is performed for the geographic area 3200 as a whole using each of the best potential configurations for the sub-regions to determine performance of the telecommunications network for the entire geographic area. In some such embodiments, the output metrics from the additional simulation may be compared with a performance threshold specified for the telecommunications network, and if the output metrics do not meet the threshold, or fall within an acceptable range, different combinations of potential configurations may be simulated together until optimal output performance metrics are achieved.

The process 3100 determines (at 3150) whether there are additional sub-regions to select. When there are additional sub-regions, the process returns to 3130 to select a sub-region. Otherwise, when there are no additional sub-regions, the process transitions to compare (at 3160) performance metrics for each configuration to identify the most optimal configuration. As described above, the metrics of some embodiments are compared against performance thresholds specified for the telecommunications network, while in other embodiments, the metrics are compared against each other (i.e., output metrics from multiple simulations for the same region) to identify the best metrics. The process 3100 then uses (at 3170) the most optimal access node configuration to define a deployment of the telecommunications network. Following 3170, the process 3100 ends.

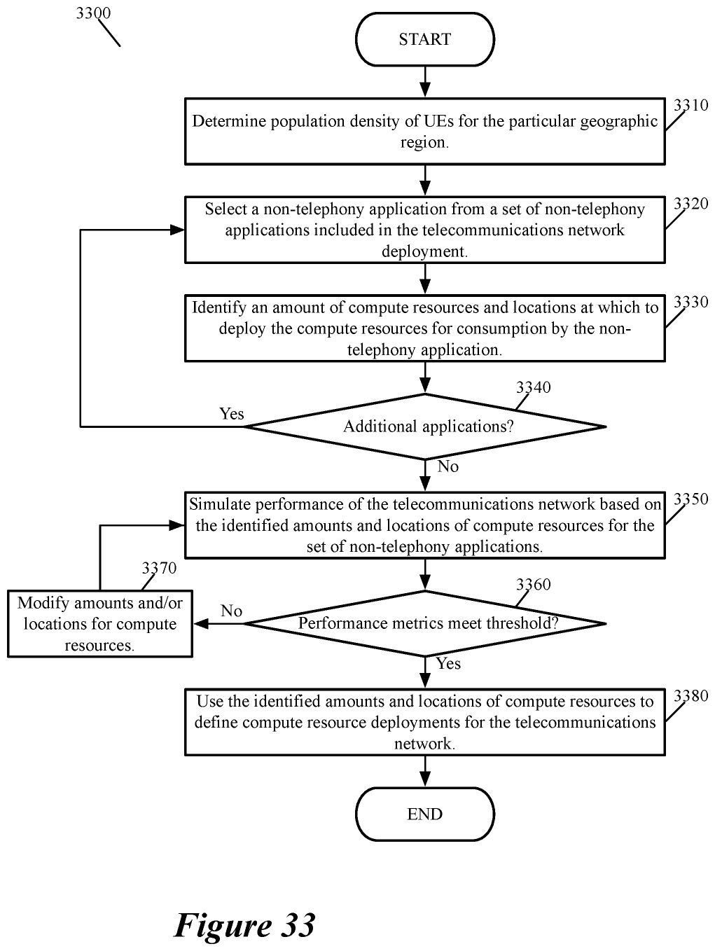

FIG. 33 conceptually illustrates a process of some embodiments for defining compute resource deployments for a telecommunications network. The process is performed in some embodiments by a function or set of functions implemented in a computer system. The process 3300 starts by determining (at 3310) population density of UEs for the particular geographic region. The population density data of some embodiments is historical population density data, while in other embodiments, the population density data is estimated for current or future UE populations.

The process 3300 selects (at 3320) a non-telephony application from a set of non-telephony applications included in the telecommunications network deployment and identifies (at 3330) an amount of compute resources and locations at which to deploy the compute resources for consumption by the non-telephony application. For instance, an application may be associated with low latency requirements (e.g., cloud gaming applications), and as such, the compute resources for the application would be best located in PoPs of the access network, according to some embodiments, while the amount of compute resources may be determined based on a current or expected number of UEs accessing the application (e.g., as described above for FIG. 11). In some embodiments, one or more templates may be used to determine compute resource amounts and deployment locations. For instance, in some embodiments, compute resource amounts and locations are determined using algorithms for defining MEC deployments.

The process 3300 determines (at 3340) whether there are additional applications for selection. When there are additional applications for selection, the process returns to 3320. Otherwise, when there are no additional applications for selection, the process transitions to simulate (at 3350) performance of the telecommunications network based on the identified amounts and locations of compute resources for the set of non-telephony applications. The simulation includes providing the identified compute resource amounts and locations as input, while the simulator simulates how the applications and, in some embodiments, other components of the telecommunications network, perform according to the input provided.

In some embodiments, the input for the compute resources also includes specifications regarding the machines to which the compute resources are to be deployed, as described above. Also, in some embodiments, in addition to the compute resource configurations, population density data (e.g., number of UEs and locations of the UEs throughout the geographic area), data associated with the geographic area (e.g., how many km²), and other relevant data are also provided as input for the simulation. For instance, the simulation in some embodiments is run to capture performance of the telecommunications network for a particular instance in time, based on historical or predicted UE behavior for that particular instance in time in order to produce a snapshot of the network's performance. In some embodiments, the process runs the simulation for each application individually rather than collectively.

The process 3300 determines (at 3360) whether performance metrics resulting from the simulation meet a performance threshold specified for the telecommunications network. For instance, if an application is associated with a latency requirement, the performance threshold may include a latency threshold or thresholds (i.e., upper and lower thresholds) to ensure application requirements are met, in some embodiments. Alternatively, or conjunctively, the performance metrics are compared with other output performance metrics that are produced based on simulations using other input sets (e.g., other compute resource configurations, other instances in time, etc.).

When the performance threshold is not met, or is not within a specified range of acceptable performance, the process 3300 transitions to modify (at 3370) the amounts and/or locations for compute resources. For example, compute resources for an application with low latency may need to be moved from a PoP in the edge network to a PoP in the access network. Rather than only modifying the compute resource configurations, other embodiments may also modify other portions of the input (e.g., reducing the geographic area to cover a smaller area).

When the performance threshold is met, the process 3300 transitions to use (at 3380) the identified amounts and locations of compute resources to define compute resource deployments for the telecommunications network. In some embodiments, the compute resource deployment is used to modify an existing compute resource deployment for the telecommunications network. In other embodiments, the compute resource deployment is the initial compute resource deployment for a telecommunications network. Following 3380, the process 3300 ends.

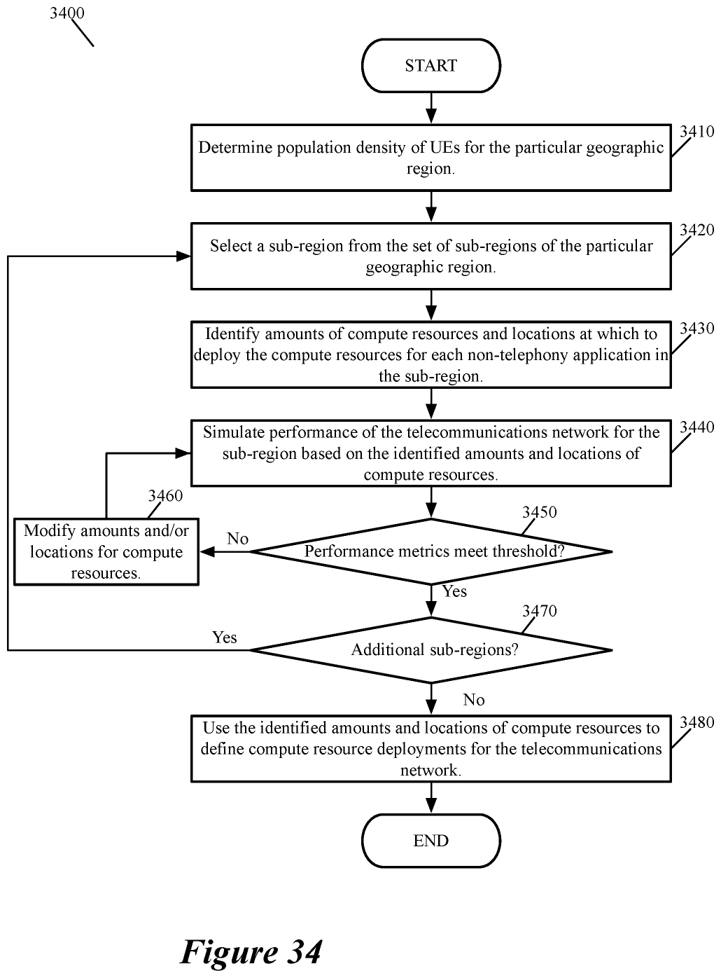

FIG. 34 conceptually illustrates a process of some embodiments for defining compute resources deployments for a telecommunications network for each sub-region within a particular geographic region. The process is performed in some embodiments by a function or set of functions implemented in a computer system. The process 3400 starts by determining (at 3410) population density of UEs for the particular geographic region. Like the embodiments described above, the population density of UEs is determined in some embodiments using estimates of current and/or future UEs in the geographic area, historical population density data, current population density data, or a combination of any of these. For instance, historical population data is used in some embodiments to generate estimates of current and/or future population densities.

The process 3400 selects (at 3420) a sub-region from the set of sub-regions of the particular geographic region and identifies (at 3430) amounts of compute resources and locations at which to deploy the compute resources for each non-telephony application in the sub-region. That is, in some embodiments, a rural region may have different application needs than a dense urban region, and as such, the compute resource deployments may differ between the different regions in order to best service users of the telecommunications network. For example, in the diagram 1400 illustrated in FIG. 14 and described above, the cells 1210 and 1214 each include more resources for app 1 than the cells 1212 and 1216. Additionally, unlike the resources for application 1 in each other cell 1210, 1212, and 1214, which are deployed in the access network 1224, the resources for application 1 in the cell 1216 are deployed in the edge network 1222.

The process 3400 simulates (at 3440) performance of the telecommunications network for the sub-region based on the identified amounts and locations of compute resources. That is, the identified amounts and locations of compute resources for the sub-region are used as input for the simulation, which simulates performance of the telecommunications network, including the applications deployed in the telecommunications network, to produce one or more sets of output metrics that are indicative of that performance. For instance, the input is run through the network infrastructure generator algorithm partially illustrated by FIG. 16 and described above, in some embodiments.

In some embodiments, the process identifies multiple potential amounts and locations to use as input for the simulation in order to generate multiple sets of output performance metrics (e.g., QoE metrics such as latency, throughput, and packet loss) for analysis. In some embodiments, the sets of output metrics also include metrics regarding compute resource usage (e.g., application X's compute resource utilization is 90%). The multiple potential amounts and locations of compute resources are identified using pre-defined templates or algorithms for defining compute resource deployments, in some embodiments, and these templates or algorithms are used as the input for the simulation. Also, in some embodiments, specifications for the machine or machines to which the compute resources are to be deployed are also included in the input. The machine specifications, in some embodiments, refer to existing machines deployed for an existing telecommunications network, while in other embodiments, the machine specifications are defined for new machines (e.g., to be deployed for existing or new networks).

In addition to the compute resource amounts and locations, some embodiments also provide other input, such as parameters corresponding to UE behavior (e.g., estimated number of UEs using a particular application at a particular instance in time). For example, the input of some embodiments specifies a number N of UEs using application X at time T, a number M of UEs using application Y at time T, and a number P of UEs using application Z at time T, and based on this input, and the compute resource deployment input, the performance of applications X, Y, and Z within the telecommunications network is simulated.

Based on the output performance metrics, the process 3400 determines (at 3450) whether those performance metrics resulting from the simulation meet a performance threshold specified for the telecommunications network. For example, in some embodiments, the performance threshold includes latency requirements, compute resource utilization requirements, throughput requirements, etc. In some embodiments, each application is associated with a respective performance threshold or thresholds defined for the telecommunications network. In some such embodiments, the thresholds may be based on external factors such as performance requirements of the application. When multiple sets of input are used for the simulation, and multiple sets of output performance metrics are produced from the simulation, some embodiments identify the set of output metrics that is closest to the defined performance threshold. When the performance threshold is not met, the process transitions to modify (at 3460) amounts and/or locations for compute resources. In other embodiments, a new set or new sets of input are generated rather than modifying the existing input.

When the performance threshold is met, the process 3400 determines (at 3470) whether there are additional sub-regions to be selected. When there are additional sub-regions to be selected, the process transitions back to 3420. Otherwise, when there are no additional sub-regions, the process 3400 uses (at 3480) the identified amounts and locations of compute resources to define compute resource deployments for the telecommunications network. As also described above, the identified amounts and locations of compute resource in some embodiments are used to modify existing deployments of compute resources, while in other embodiments, the identified amounts and locations of compute resources are the initial amounts defined for the telecommunications network. Following 3480, the process 3400 ends.

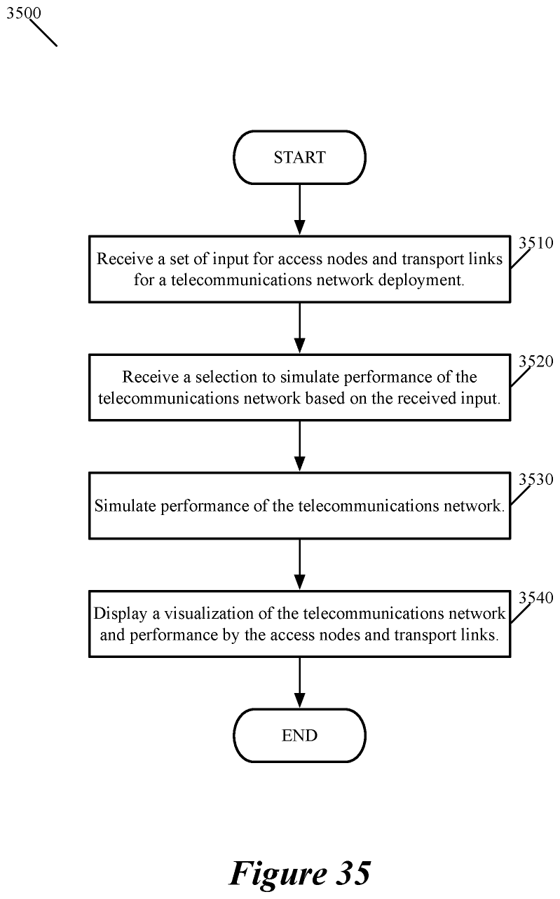

FIG. 35 conceptually illustrates a process of some embodiments for displaying a visualization of a telecommunications network based on a simulation performed using access node and transport link configurations as input. The process 3500 is also performed by the network infrastructure generator described above based on input received through a UI from a user (e.g., network administrator) in some embodiments. The process 3500 starts when it receives (at 3510) a set of input for access nodes and transport links for a telecommunications network deployment. In some embodiments, the set of input includes multiple subsets of input for the access nodes and for the transport links. These multiple subsets of input, in some embodiments, can include parameters for generating the deployments, as well as, or instead of, templates that define the deployments.

The process 3500 receives (at 3520) a selection to simulate performance of the telecommunications network based on the received input and simulates (at 3530) performance of the telecommunications network. In some embodiments, the process receives multiple sets of input at the same time for multiple simulations, or receives input that causes multiple simulations to be performed, such as an algorithm designed to evaluate multiple different deployments. For instance, in some embodiments, a user may provide simultaneous input associated with access node deployments and transport link deployments. In some such embodiments, each set of input may include multiple different templates or parameters for generating templates for the simulation in order to produce multiple sets of output performance metrics for use in identifying the most optimal deployments for the access nodes and transport links.

The process 3500 displays (at 3540) a visualization through a UI of the telecommunications network and performance by the access nodes and transport links. For example, in some embodiments, the process provides a visualization such as the graph 2520 in the UI 2500, which also enables a user to modify the configurations, according to some embodiments, as shown in the graph 2620. In some embodiments, the simulation is performed for the purpose of defining a new telecommunications network deployment, while in other embodiments, the simulation is performed for the purpose of modifying an existing deployment. Following 3540, the process 3500 ends.

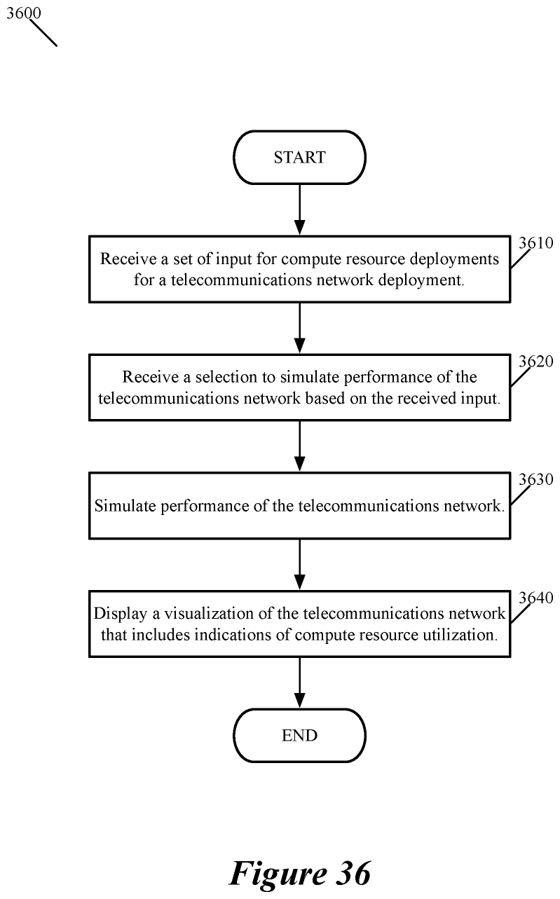

FIG. 36 conceptually illustrates a process of some embodiments for displaying a visualization of a telecommunications network following simulation of performance by the telecommunications network. The process 3600 is also performed in some embodiments by the network infrastructure generator described above based on input received through a UI from a user (e.g., network administrator). The process 3600 starts when it receives (at 3610) a set of input for compute resource deployments for a telecommunications network deployment. In some embodiments, the amount of compute resources is determined using an algorithm for network slicing deployments or MEC deployments, and the algorithm is provided as the input.

The process 3600 receives (at 3620) a selection to simulate performance of the telecommunications network based on the received input and simulates (at 3630) performance of the telecommunications network. In some embodiments, telecommunications network infrastructure is random and realistic to allow the different compute resource deployments to be evaluated on a variety of infrastructures, while in other embodiments, a particular infrastructure is defined and used for the simulation. For instance, in some embodiments, the process 3600 is performed to identify a compute resource deployment to modify an existing deployment, and, as such, the simulated infrastructure is defined to mimic the existing infrastructure.

The process then displays (at 3640) a visualization of the telecommunications network that includes indications of compute resource utilization. For example, the process may display a UI 1700 that includes multiple options for viewing the performance and modifying the compute resource deployment. In some embodiments, the UI may also provide suggestions for modifying the deployments to improve performance, such as suggestions to increase compute resource allocation amounts for certain applications, decrease compute resource allocation amounts for certain applications, move compute resources from one non-core network to another non-core network for certain applications, etc. Following 3640, the process 3600 ends.

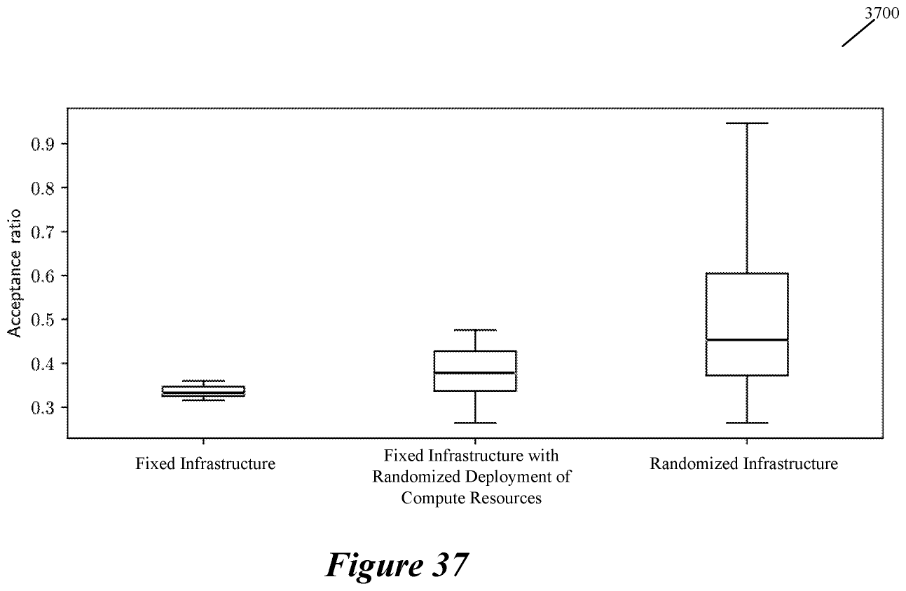

In some embodiments, the randomized deployments provided by the infrastructure generator described above results in better acceptance rates for service graphs during simulations. FIG. 37 compares, in terms of ratio of accepted service graphs, the cases of fixed infrastructure, fixed infrastructure with randomized deployment of compute resources, and randomized infrastructure. The base test for all is an attempt to embed 500 service graphs. This test is repeated 20 times with different random seeds. The fixed infrastructure with randomized deployment of compute resources evaluates this over ten randomized deployments of compute resources on the same infrastructure. The randomized infrastructure evaluates over ten random infrastructures. The graph 3700 shows that with a fixed infrastructure, the range of results obtained only shows a small portion of the possible behavior of the SGE algorithm, and in order to understand the algorithm's performance in all corner cases, it is crucial to fully randomize the infrastructure.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

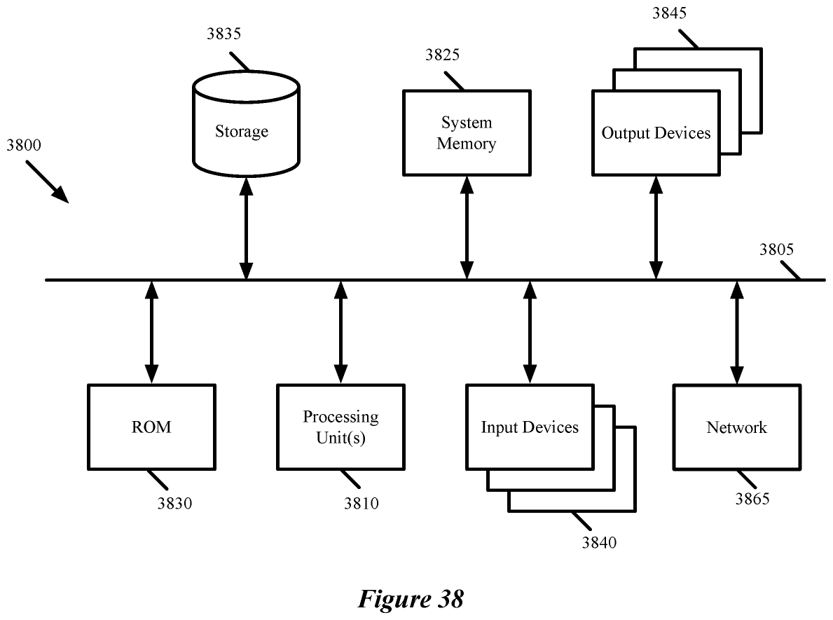

FIG. 38 conceptually illustrates a computer system 3800 with which some embodiments of the invention are implemented. The computer system 3800 can be used to implement any of the above-described hosts, controllers, gateway, and edge forwarding elements. As such, it can be used to execute any of the above described processes. This computer system 3800 includes various types of non-transitory machine-readable media and interfaces for various other types of machine-readable media. Computer system 3800 includes a bus 3805, processing unit(s) 3810, a system memory 3825, a read-only memory 3830, a permanent storage device 3835, input devices 3840, and output devices 3845.

The bus 3805 collectively represents all system, peripheral, and chipset buses that communicatively connect the numerous internal devices of the computer system 3800. For instance, the bus 3805 communicatively connects the processing unit(s) 3810 with the read-only memory 3830, the system memory 3825, and the permanent storage device 3835.

From these various memory units, the processing unit(s) 3810 retrieve instructions to execute and data to process in order to execute the processes of the invention. The processing unit(s) 3810 may be a single processor or a multi-core processor in different embodiments. The read-only-memory (ROM) 3830 stores static data and instructions that are needed by the processing unit(s) 3810 and other modules of the computer system 3800. The permanent storage device 3835, on the other hand, is a read-and-write memory device. This device 3835 is a non-volatile memory unit that stores instructions and data even when the computer system 3800 is off. Some embodiments of the invention use a mass-storage device (such as a magnetic or optical disk and its corresponding disk drive) as the permanent storage device 3835.

Other embodiments use a removable storage device (such as a floppy disk, flash drive, etc.) as the permanent storage device. Like the permanent storage device 3835, the system memory 3825 is a read-and-write memory device. However, unlike storage device 3835, the system memory 3825 is a volatile read-and-write memory, such as random access memory. The system memory 3825 stores some of the instructions and data that the processor needs at runtime. In some embodiments, the invention's processes are stored in the system memory 3825, the permanent storage device 3835, and/or the read-only memory 3830. From these various memory units, the processing unit(s) 3810 retrieve instructions to execute and data to process in order to execute the processes of some embodiments.

The bus 3805 also connects to the input and output devices 3840 and 3845. The input devices 3840 enable the user to communicate information and select commands to the computer system 3800. The input devices 3840 include alphanumeric keyboards and pointing devices (also called “cursor control devices”). The output devices 3845 display images generated by the computer system 3800. The output devices 3845 include printers and display devices, such as cathode ray tubes (CRT) or liquid crystal displays (LCD). Some embodiments include devices such as touchscreens that function as both input and output devices 3840 and 3845.

Finally, as shown in FIG. 38, bus 3805 also couples computer system 3800 to a network 3865 through a network adapter (not shown). In this manner, the computer 3800 can be a part of a network of computers (such as a local area network (“LAN”), a wide area network (“WAN”), or an Intranet), or a network of networks (such as the Internet). Any or all components of computer system 3800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for defining a telecommunications network deployment for a particular geographic region comprised of a set of sub-regions, the telecommunications network comprising an access network, an edge network and a core network, the method comprising:
for each UE in a plurality of UEs distributed across the particular geographic region,
selecting a traffic category from a set of traffic categories to associate with the UE; and
based on the selected traffic category, using an application traffic model to compute an upper threshold limit of an attainable data rate for the UE;
for each link in a plurality of transport links that connect the plurality of UEs to the telecommunications network, determining a link capacity for each transport link based on the upper threshold limits of the attainable data rates computed for each UE in the plurality of UEs;
simulating performance of the telecommunications network based on the determined link capacities for the plurality of transport links; and
when a set of performance metrics resulting from simulating performance of the telecommunications network meet a performance threshold specified for the telecommunications network, using the determined link capacities to define the telecommunications network deployment for the particular geographic region.

2. The method of claim 1, wherein the set of traffic categories comprises (i) web browsing traffic, (ii) file transfer traffic, and (iii) video streaming traffic.

3. The method of claim 1, wherein:
each UE in the plurality of UEs is assigned a data rate limit by a modulation and coding scheme (MCS); and
the upper threshold limit of the attainable data rate for each UE in the plurality of UEs is less than the data rate limit assigned to the UE by the MCS.

4. The method of claim 3, wherein the MCS assigns data rate limits based on signal quality associated with each UE.

5. The method of claim 4, wherein:
UEs associated with a signal quality above a particular threshold specified for signal quality are assigned high data rates; and
UEs associated with a signal quality below the particular threshold specified for signal quality are assigned low data rates.

6. The method of claim 5, wherein the low data rates enable communication reliability for the UEs associated with a signal quality below the particular threshold to be maintained.

7. The method of claim 1, wherein:
UEs connect to the telecommunications network via a plurality of access nodes; and
using the application traffic model to compute the upper threshold limits of attainable data rates for each UE in the plurality of UEs based on the selected traffic category for the UE comprises computing the upper threshold limit of the attainable data rate for the UE based on (i) the UE's distance from a nearest access node and (ii) a path loss model that predicts path loss experienced by a signal associated with the UE.

8. The method of claim 7, wherein the path loss model uses a path loss exponent calculated based on a probability of Line of Sight between the UE and a nearest access node.

9. The method of claim 1, wherein determining the link capacity for each transport link based on the upper threshold limits of the attainable data rates computed for each UE in the plurality of UEs comprises, for each transport link in the plurality of transport links, using the upper threshold limits of the attainable data rates of each UE in the plurality of UEs and an expected traffic demand associated with each UE in the plurality of UEs to compute an upper threshold limit for an expected load for the particular geographic region.

10. The method of claim 9, wherein the upper threshold limit for the expected load for the particular geographic region comprises an aggregation of upper threshold limits for expected loads computed for each sub-region in the set of sub-regions.

11. The method of claim 9, wherein the upper threshold for the expected load for the particular geographic region comprises a minimum between (i) the upper threshold limits of the attainable data rates for each UE and (ii) traffic demand associated with each UE.

12. The method of claim 11, wherein the upper threshold limit for the expected load for the particular geographic region comprises a maximum expected load for the particular geographic region, wherein the determined link capacity for each transport link in the plurality of transport links comprises a link capacity that can support at least 95% of the maximum expected load for the particular geographic region.

13. The method of claim 1, wherein the plurality of transport links comprise (i) point-to-point links, (ii) broadcast links, (iii) multipoint links, (iv) point-to-multipoint links, (v) public links, and (vi) private links.

14. The method of claim 1, wherein the plurality of transport links comprises wired links and wireless links.

15. The method of claim 14, wherein the wired links comprise coaxial cables and fiber optic cables.

16. A non-transitory machine readable medium storing a program for execution by a set of processing units, the program for defining a telecommunications network deployment for a particular geographic region comprised of a set of sub-regions, the telecommunications network comprising an access network, an edge network and a core network, the program comprising sets of instructions for:
for each UE in a plurality of UEs distributed across the particular geographic region,
selecting a traffic category from a set of traffic categories to associate with the UE; and
based on the selected traffic category, using an application traffic model to compute an upper threshold limit of an attainable data rate for the UE;
for each link in a plurality of transport links that connect the plurality of UEs to the telecommunications network, determining a link capacity for each transport link based on the upper threshold limits of the attainable data rates computed for each UE in the plurality of UEs;
simulating performance of the telecommunications network based on the determined link capacities for the plurality of transport links; and
when a set of performance metrics resulting from simulating performance of the telecommunications network meet a performance threshold specified for the telecommunications network, using the determined link capacities to define the telecommunications network deployment for the particular geographic region.

17. The non-transitory machine readable medium of claim 16, wherein the set of traffic categories comprises (i) web browsing traffic, (ii) file transfer traffic, and (iii) video streaming traffic.

18. The non-transitory machine readable medium of claim 16, wherein:
each UE in the plurality of UEs is assigned a data rate limit by a modulation and coding scheme (MCS);
the upper threshold limit of the attainable data rate for each UE in the plurality of UEs is less than the data rate limit assigned to the UE by the MCS; and
the MCS assigns data rate limits based on signal quality associated with each UE.

19. The non-transitory machine readable medium of claim 18, wherein:
UEs associated with a signal quality above a particular threshold specified for signal quality are assigned high data rates;
UEs associated with a signal quality below the particular threshold specified for signal quality are assigned low data rates; and
the low data rates enable communication reliability for the UEs associated with a signal quality below the particular threshold to be maintained.

20. The non-transitory machine readable medium of claim 16, wherein the plurality of transport links comprises (i) point-to-point links, (ii) broadcast links, (iii) multipoint links, (iv) point-to-multipoint links, (v) public links, and (vi) private links.
